(19) United States
(12) Patent Application Publication
(10) Pub. No.: US 2017/0061005 A1
(43) Pub. Date: Mar. 2, 2017

(54) Automatic Background Information Retrieval and Profile Updating

(71) Applicant: Google Inc., Mountain View, CA (US)

(72) Inventors: Sean Edward Purcell, San Francisco, CA (US); Zhong Wang, Redmond, WA (US); Min Zhong, Mountain View, CA (US); Eric Lobdell, San Francisco, CA (US); Christian Bohland, Santa Cruz, CA (US); Mayuresh Saoji, Fremont, CA (US)

(21) Appl. No.: 14/835,581

(22) Filed: Aug. 25, 2015

(51) Int. Cl. G06F 17/30; H04L 29/08

(52) U.S. Cl. CPC G06F 17/30864; H04L 67/306

(57) ABSTRACT

The present disclosure relates to automatically retrieving, providing and updating information for a user. The present disclosure includes a method comprising receiving, using one or more computing devices, an attribute associated with an action of a first user on a mobile computing device; retrieving, using the one or more computing devices, profile information associated with the attribute from a first global database; determining, using one or more computing devices, whether to update a profile with the profile information; and responsive to determining to update the profile, providing, using one or more computing devices, the information for storage in the profile.

### BACKGROUND

The present disclosure relates to automatically retrieving, providing and updating profile information for a user. In particular, the present disclosure relates to automatically retrieving information in the background from various databases, providing it on mobile devices and updating the profile of a user with the information.

In the last decade or so, social networks have become increasingly popular. People can share important moments of their life with their friends even though they live far away from each other. Similarly, people can follow businesses that they are interested in on a social network so that they receive more real-time information about the businesses they like. Therefore, it is important for users to make sure that they connected with their friends or followed the businesses.

When communicating using mobile devices, people tend to place or receive phone calls, send and receive text messages or send and receive email messages to communicate with their friends. In this case, they may or may not have be connected with the same people in the social networks they use. Furthermore, under other circumstances, for example, when a user receives a call from a strange number which is not in the user's contact information, it may confuse the user. This is particularly true when a second user associated with this number called the first user several times during the past week for the purpose of discussing some particular event and the user does not save the phone number as a contact.

### SUMMARY

The present disclosure relates to systems and methods for automatically retrieving, providing and updating information for a user. According to one innovative aspect of the subject matter in this disclosure, a system having one or more processors and a memory storing instructions that, when executed, cause the system to: receive an attribute associated with an action of a first user on a mobile computing device; retrieve profile information associated with the attribute from a first global database; determine whether to update a profile with the profile information; and responsive to a determination to update the profile, provide the profile information for storage in the profile.

In general, another innovative aspect of the subject matter described in this disclosure may be implemented in methods that include receiving, using one or more computing devices, an attribute associated with an action of a first user on a mobile computing device; retrieving, using the one or more computing devices, profile information associated with the attribute from a first global database; determining, using one or more computing devices, whether to update a profile with the profile information; and responsive to determining to update the profile, providing, using one or more computing devices, the profile information for storage in the profile.

Another innovative aspect of the subject matter described in this disclosure may be implemented in methods that include detecting an action performed by a first user on a mobile computing device; determining, using the mobile computing device, an attribute associated with the detected action; retrieving, using the mobile computing device, profile information associated with the attribute from an external database; and providing, using the mobile computing device, the profile information for storage in a profile of the first user.

Other implementations of one or more of these aspects include corresponding systems, apparatus, and computer programs, configured to perform the actions of the methods, encoded on computer storage devices.

These and other implementations may each optionally include one or more of the following operations. For instance, the operations wherein the action is sending or receiving a telephone call using the mobile computing device; wherein the action is creating or modifying contact information stored on the mobile computing device; wherein the profile of the first user is part of contact information stored on the mobile computing device; wherein the profile of the first user is on a social network service; and determining whether the first user has dismissed a prior notification to update the profile with the profile information. For instance, the operations further include: providing the profile information for storage includes updating a social graph of the first user with a second user determined from the profile information; determining whether to present the profile information on the mobile computing device, and responsive to a determination to present the profile information on mobile computing device, generating a notification including the profile information and providing the notification for display on the mobile computing device. For instance, the operations also may include receiving a calling signal; determining a parameter from the calling signal; determining whether the parameter from the calling signal satisfies a predefined threshold; and responsive to a determination that the parameter satisfies the predefined threshold, updating the profile with the profile information. For instance, the operations also may include receiving a social signal; determining a parameter from the social signal; determining whether the parameter from the social signal satisfies a predefined threshold; and responsive to a determination that the parameter satisfies the predefined threshold, updating the profile with the profile information. For instance, the operations further include: identifying one or more global databases to which the first user has access; selecting a first database from the one or more global databases based on frequency of use of the one or more global databases; sending a query to the first database; and receiving and using a query result from the first database as the profile information. For instance, the operations further include: determining whether to generate a notification to the first user; responsive to a determination to generate the notification, generating the notification including the profile information; providing the notification for presentation to the first user; receiving a confirmation to update the profile of the first user; and responsive to receiving the confirmation, storing the profile information in the profile of the first user. For instance, the operations further include: identifying a plurality of social networks on which the first user has a profile; selecting a social network from the plurality of social networks based on a predetermined rule; and updating the profile of the first user in the selected social network with the profile information.

These implementations are particularly advantageous in a number of respects. For instance, the automatically retrieving, providing and updating information for a user eliminates the need for manual input of redundant data by the user. Moreover, the technology allows users to increase the number of others with which they have relationships on social networks. The present technology is also advantageous because the user may be notified prior to addition of any additional information to their contact information or profile information. Further, the presentation of notifications about changes to the user's contact information (e.g., profiles and contacts) can be adapted to the preferences and desires of the user.

It should be understood, however, that the above features and advantages are not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a flowchart of an example method of retrieving profile information and updating a user's a profile.

FIG. 2 is a flowchart of an example method of retrieving profile information and updating user's social graph with the retrieved profile information.

FIG. 3 is a flowchart of another example method of retrieving profile information and updating user's social graph with the retrieved profile information.

FIG. 4 is a flowchart of an example method of retrieving profile information and generating a notification including the profile information.

FIG. 5 is a flowchart of an example method of retrieving profile information and updating a user's a profile modified to cooperate with other systems.

FIG. 6 is a flowchart of an example method of retrieving profile information and updating a user's a profile including consideration of past user interactions.

FIG. 7 is a graphic representation of an example user interface showing actions or activities that trigger retrieval of profile information.

FIG. 8 is a graphic representation of an example user interface for setting user preferences.

FIGS. 9A-9D are graphic representations of example notifications for presenting profile information in response to a phone call.

FIGS. 10A-10D are a graphic representations of example notifications for presenting profile information in response to modification of a contact.

FIG. 11 is a graphic representation of example user interface for a contact of a user with profile information.

FIG. 12 is a block diagram illustrating an example system for retrieving profile information and updating a user's a profile.

FIG. 13 is a block diagram illustrating an example of client device including a profile updating application.

FIG. 14 is a block diagram illustrating an example of a server device including a profile retrieval application.

### DETAILED DESCRIPTION

The specification discloses a system and method for retrieving, providing and updating information for a user. In particular, the present disclosure relates to automatically retrieving information in the background from various databases, providing it on mobile devices and updating the profile of a user with the profile information. The profile updating application detects an action or activity by a first user on a mobile computing device or client device. More specifically, the profile updating application detects an activity related to contact information on the client device. For example, the activity can be a modification of a contact record in the contact information of the client device (e.g., mobile computing device). In another example, the profile updating application detects an activity related use of the mobile computing device or client device as a phone. For example, the activity can be making or receiving a phone call using the client device. The profile updating application retrieves one or more attributes associated with the detected activity. For example, when there is a call on the client device, the attribute can be the phone number; when there is a modification of a contact in the contact information, the attribute can be one or more of the fields in the contact record for the contact, e.g., a phone number, a name, the email address of the user, the address of the user, the birthday of the user, a uniform resource locator (URL) of the user's page, etc. In some instances, the profile updating application retrieves the profile information associated with the one or more attributes from a global database or an external database. For example, the profile updating application determines an identifier (ID) associated with these attributes and retrieves the profile information corresponding to the ID. The identifier could be a social network ID, an email identifier, a business name, a user's name or the like. Some of these operations may be performed by the profile updating application alone while for others the profile updating application cooperates with the profile retrieval application to perform them as will be described below.

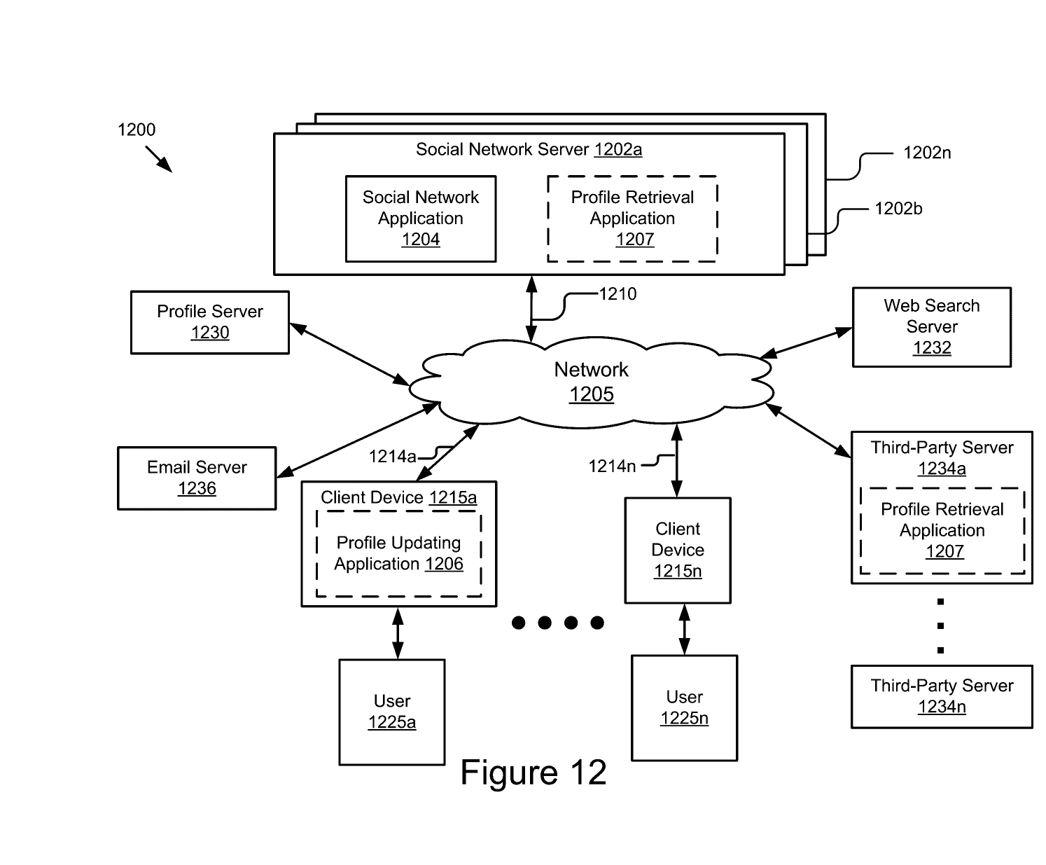

In some instances, the profile updating application provides a notification for presentation to the first user of the client device. In general in the description that follows unless specifically stated otherwise, the first user will be used to refer to the user of a mobile computing device or client device (e.g., user 1225a of client device 1215a, see FIG. 12) The notification can include the various types of information including communication history (e.g., email exchange and phone calls etc.) between the first user and a second user associated with the detected activity, retrieved profile information, the social network ID associated with the attributes, or a request for the first user to approve an action (e.g., whether the first user wants to add the second user as a connection in a social network). In some instances, the profile updating application receives an input responsive to the notification from the first user. For example, the input may indicate that the first user wants to connect with the second user on the social network or that the user wants to store the profile information of the second user as a contact in the contact information on the client device. The profile retrieval application updates the first user's social graph on a social network with the profile information based on the input from the user. For example, responsive to the user's input indicating that the first user wants to connect with the second user, the profile retrieval application cooperates with the social network application to add other users as a connection on a social network.

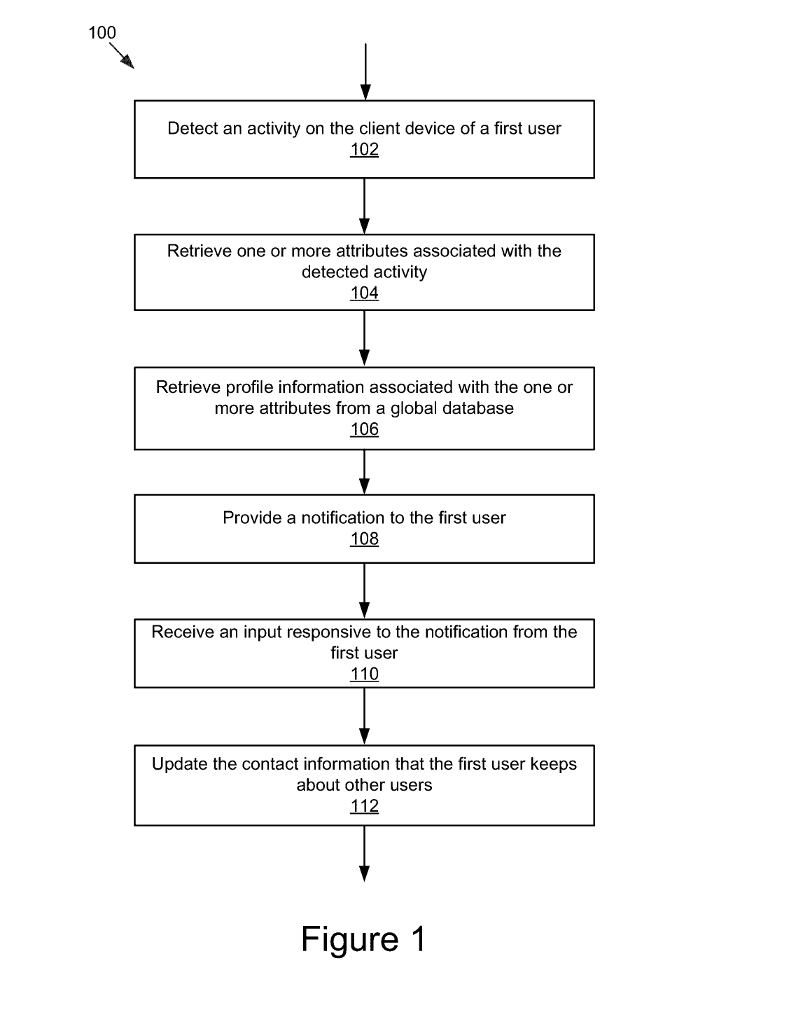

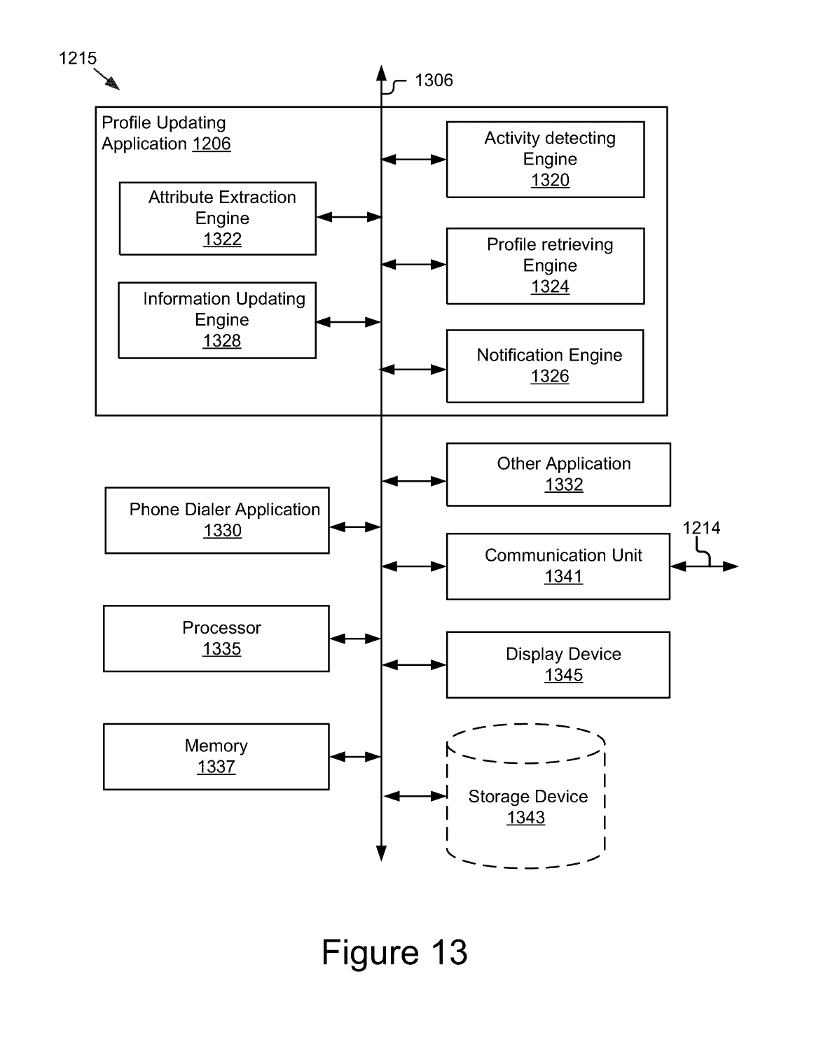

FIG. 1 is a flowchart of an example method 100 of retrieving profile information and updating a user's a profile. While the method 100 will be described below as being performed by the profile updating application 1206 of the client device 1215, it should be understood that the method 100 may be performed by a profile retrieval application 1207 of a social network server 1202 or a combination of the profile updating application 1206 and the profile retrieval application 1207. The profile updating application 1206 may include an activity detecting engine 1320, an attribute extraction engine 1322, a profile retrieving engine 1324, a notification engine 1326 and an information updating engine 1328. The profile updating application 1206 is described in more detail below with reference to FIG. 13.

In some instances, the method 100 is triggered or initiated when the activity detecting engine 1320 detects 102 an action or activity by a first user on the client device 1215 of the first user. For example, the action or activity can be a phone call received or placed using the client device 1215 or a creation or modification of a contact record in the contact information of the client device 1215. In some instances, the detection is performed by the client device 1215. In some instances, the client device 1215 notifies other devices that an action or activity has been detected.

The method 100 continues with the attribute extraction engine 1322 determining or retrieving 104 one or more attributes associated with the detected activity. For example, when the detected activity is a call on the client device 1215, the attribute can be the phone number. The phone number may be determined by accessing the dialer functionality of the client device 1215 or using caller identification (ID) that is transmitted as part of the call. In another example, when the detected activity is a modification of a contact record in the contact information, the attribute(s) can be one or more of any information stored in the contact information, e.g., a phone number, a name, the email address of the user, the address of the user, the birthday of the user, a URL of the user's page, etc.

The method 100 continues having the profile retrieving engine 1324 retrieve 106 the profile information associated with the one or more attributes from a global database. For example, the one or more attributes may be used to retrieve the profile information from any database external to the client device 1215, e.g., those databases of a social network server 1202, a profile server 1230, a web search server 1232, an email server 1236 or a third party server 1234. One example of a third party server 1234 is a “white pages” server that can receive a phone number and response provides a user name. In some instances, the profile updating application 1206 cooperates with the profile retrieval application 1207 of the social network server 1202 to look up a social network ID associated with the one or more attributes and retrieves the profile information associated with the social network ID. That profile information is sent from the social network server 1202 to the client device 1215. Similarly, other query or search operations may be performed using the one or more attributes on the profile server 1230, web search server 1232, email server 1236 or third party server 1234 to similarly generate profile information.

The method 100 continues by generating and providing 108 a notification to the first user. The method 100 generates 108 a notification using the profile information retrieved in block 106. The method 100 processes the profile information retrieved in block 106 to determine what information to include in the notification. For example, new or non-redundant information (e.g., information not already stored on the client device 1215) may be determined and selected for inclusion in the notification. Moreover, portions of the profile information may be prioritized over other information. By way of example, name, phone number and email address may be prioritized over other information like photos, dates, comments, etc.

In some instances, the notification engine 1326 determines whether to provide 108 the notification to the first user of the client device 1215. The notification engine 1326 may run different algorithms or tests on social signals, calling signals, the profile information itself or combinations thereof to determine whether to provide 108 the notification to the first user. For example, the calling signals can be used and the notification may include the various types of communication history (e.g., the frequency, recency and number of emails and/or phone calls) between the first user and a second user associated with the detected activity. In another example, social signals can be used and the notification may include the profile information or the social network ID associated with the attributes. The social signals may include posting, commenting, resharing, endorsing, recommending, presence or not in a user's social graph, degree of separation between users in a social graph, social actions on content from another user, etc. In yet another example, other signals (e.g., relevance rank, location, etc.), may be used to determine a portion of the profile information (information about one business that is geographically closer to the first user than another business) to include in the notification. In still another example, the notification may include a request to the first user regarding whether the first user wants to take a particular action (e.g., add the second user as a connection in a social network) related to the profile information.

Next, the method 100 with the information updating engine 1328 receives 110 input from the first user responsive to the notification. The input may indicate that the first user wants to perform the action requested in the notification. For example, input may indicate that the first user wants to connect with the second user on social network. In another example, the input may indicate that the first user wants to store the profile information of the second user as a contact in the contact information on the client device 1215.

The method 100 continues by updating 112 the contact information that the first user keeps about the second user or other users. In some instances, the method 100 stores the profile information in a profile of a second user in the contact information of the first user. For example, the profile on the client device 1215 may be updated with the profile information from the external database. In another example, the information of the first user on the profile server 1230, web search server 1232, email server 1236 or third party server 1234 may be updated with the profile information. In a particular example, the information updating engine 1328 updates 112 the first user's social graph on a social network with the profile information based on the input from the user. For example, responsive to the first user's input indicating that the first user wants to connect with the second user, the social network adds the second user as a connection of the first user on a social network.

In some instances, the information updating engine 1328 updates the contact information of the first user in multiple external databases with the retrieved profile information associated with the second user (e.g., a name, a phone number, a location, etc.). For example, the information updating engine 1328 may update a contact list of the first user in an external database directed to business networking with a name and a phone number of a service provider in response to receiving a call from the service provider. Or, based on a call from the first user to a journal editor who is working on publication of an article of the first user, the information updating engine 1328 may update a publication group of the first user in an external database centered on academics with available hours of the journal editor. Or the information updating engine 1328 may update a match list of the first user in an external database directed to dating with a name, a photo, a meeting time, a meeting location of a contact in response to saving the contact that matches user interests of the first user. Or the information updating engine 1328 may add a new contact name in a social graph of the first user in different social networks.

In some instances, in addition to updating the contact information of the first user with the retrieved information associated with the second user, the information updating engine 1328 also connects the first user to the second user. The second user may be associated with a call with the first user and determined by the phone number of the call. The second user may also be a new contact saved in the external database. In some instances, the information updating engine 1328 may suggest a connection between the first user and the second user and actually establish the connection between the first user and the second user in response to receiving an acceptance of the suggested connection from at least one of the first and second users. In other instances, the information updating engine 1328 may notify the first user to connect with the second user.

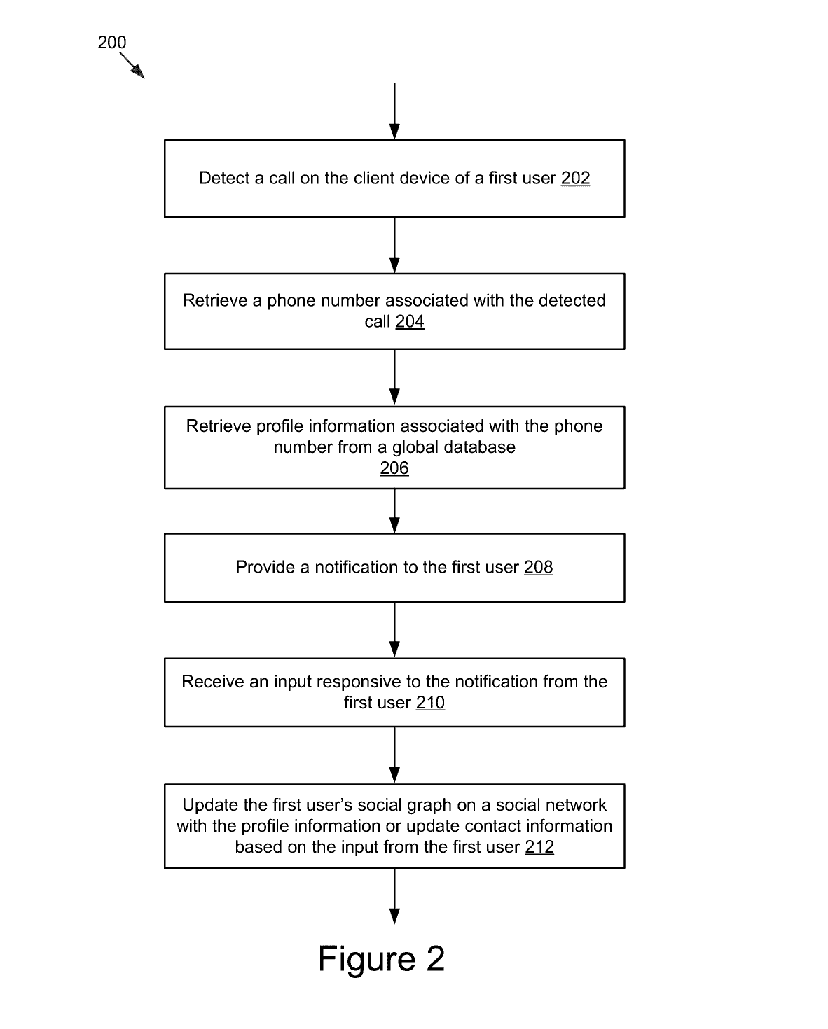

Referring now to FIG. 2, an example method 200 of retrieving profile information and updating the first user's social graph with the retrieved profile information in response to a phone call will be described. The method 200 begins with the activity detecting engine 1320 detecting 202 a call on the client device 1215. For example, the call can be an incoming phone call to or an outgoing phone call from the client device 1215. The attribute extraction engine 1322 retrieves 204 one or more attributes associated with the detected call. For example, the attribute can be the phone number of the call. In some instances, the attribute extraction engine 1322 has default permission to access the call information. In other instances, the profile updating application 1206 may ask for permission, for example, with READ_CALL_LOG command. In some instances, the attribute extraction engine 1322 determines whether the phone number is for an individual or a business. If a business, the search for the profile information may be on the web search server 1232 for the business name, address and other information. If the phone number is for an individual then the search for the profile information may be on the profile server 1230 or the social network server 1202. Thus, it should be understood that the attributes may determine which external databased are searched. The profile retrieving engine 1324 retrieves 206 the profile information associated with the phone number from a global database associated with one of the aforementioned servers. For example, the profile updating application looks up for the social network ID associated with the phone number and retrieves the profile information corresponding to social network ID from the social network server 1202. To be more specific, if the phone number associated with the detected call is (111) 222-3333, the profile updating application 1206 looks up an associated social network ID corresponding to this phone number, and it turns out to be a user named “John Doe.” The profile updating application 1206 retrieves the profile information associated with the social network ID John Doe. The profile information associated with the social network ID John Doe may include the same, less, more or different profile information that available on the client device 1215. This profile information may include an age, geographical location, profile photo, phone number, work information, education, browsed content, registered applications, groups joined by a user associated with the number, etc.

The notification engine 1326 generates and provides 208 a notification to the first user of the client device 1215. The notification can include the various types of communication history, e.g., email exchange and phone calls etc., between the first user and a second user associated with the detected call. In another example, the notification can include the retrieved profile information or the social network ID associated with the attributes. In yet another example, the notification can include query to the first user regarding whether the user wants to add the second user as a connection. The information updating engine 1328 receives 210 an input responsive to presentation of the notification from the first user. For example, the input may indicate that the first user wants to connect with the second user on a social network. In another example, the input may indicate that the user wants to store the profile information of the second user as a contact in the contact information on the client device 1215. The information updating engine 1328 adds 212 the profile information to the first user's social graph on a social network based on the input from the user. For example, responsive to the user's input indicating that the first user wants to connect with the second user, the social network adds the other users as a connection on a social network. In some embodiments, rather than updating 212 the first user's social graph, the information updating engine 1328 updates 212 the contact information of the first user on the client device 1215 by adding the profile information to the contact information. This method 200 is particularly advantageous because it uses the activity (a phone call) as a way to expand the first user's social graph by automatically adding connections based on the activity. Furthermore, while block 208 has been presented as part of the method 200 above, it should be recognized in some instances, the method 200 automatically updates the profile of the first user in the social network without providing a notification or receiving input from the user. Still furthermore, the method 200 may update the contact information or the social graph of the first user in multiple social networks and external databases. For example, the information updating engine 1328 may update contact information of the first user in a first external database centered on career connections with a new employer of a second user, and add profile information of a new third user to the social graph of the first user in a second social network.

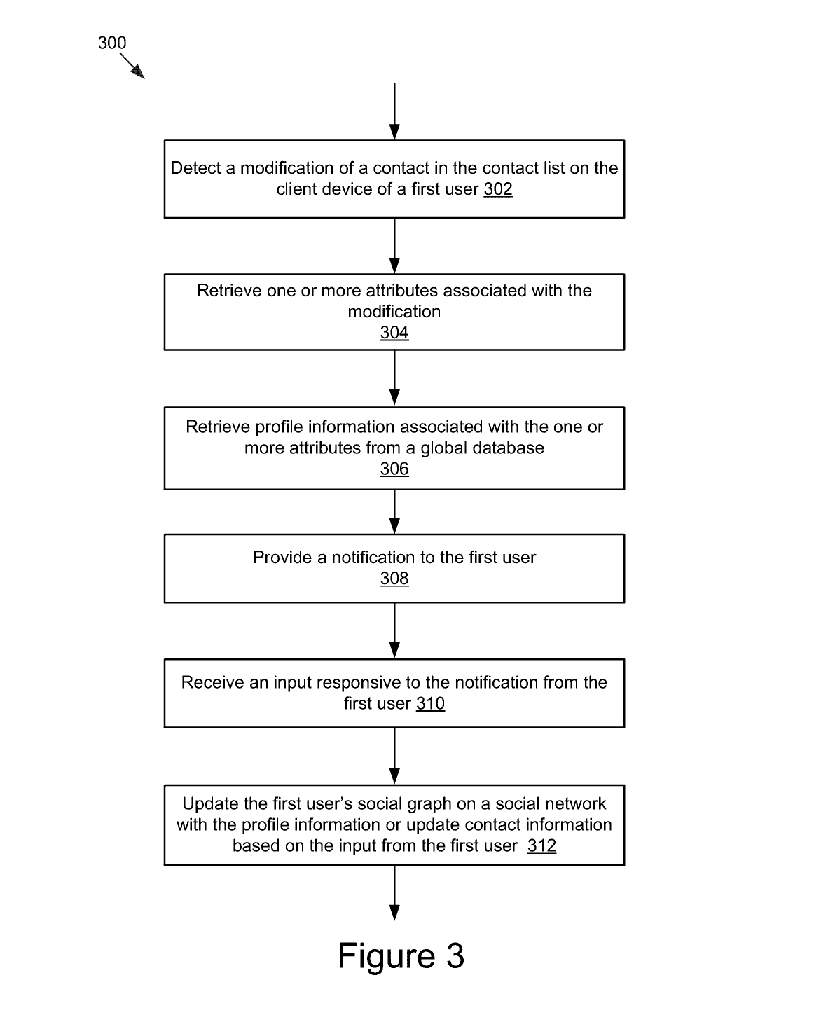

Referring now to FIG. 3, an example method 300 for updating a user's social graph with profile information in response to modification of a contact will be described. The activity detecting engine 1320 detects 302 a modification of a contact record in the contact information on the client device 1215 of a first user. For example, the modification can be adding a new contact record in the contact information of the client device 1215. In another example, the modification can be modifying an existing contact record with new information added/edited to the existing contact item in the contact information of the client device 1215. In the modification case, the first user modifies a field of an existing contact item with one or more of the following: a mobile phone number, an email address, a photo of the contact, a real name or nickname of the contact, a birthday of the user, a URL of the user's page, etc. The attribute extraction engine 1322 retrieves 304 one or more attributes (e.g., the data put into modified fields) related to the changed caused by the detected modification. For example, the attribute extraction engine 1322 may retrieve the name or other identifying information from the contact record that was modified. The profile retrieving engine 1324 retrieves 306 profile information associated with the one or more attributes from a global database. For example, the profile updating application 1206 may retrieve the social network ID associated with the attributes from block 304 and retrieves profile information of the social network ID. The profile information may be any portion or all of the profile information stored in the social network application 1204 and associated with the social network ID.

The notification engine 1326 generates and provides 308 a notification to the first user of the client device 1215. The notification can include the various types of communication history (e.g., email exchange and phone calls etc.,) between the first user and a second user associated with the detected activity. In another example, the notification can include the retrieved profile information or the social network ID associated with the attributes from block 306. In yet another example, the notification can include a confirmation request to the first user regarding whether the first user wants to add the second user as a connection. The information updating engine 1328 receives 310 an input responsive to the notification from the first user. For example, the input may indicate that the first user wants to connect with the second user on social network. In another example, the input may indicate that the user wants to store the profile information of the second user as a contact in the contact information on the client device 1215. For example, the information may include an email address or mobile phone number of the second user, and that information may be presented and stored in the client device. In another example, the information may include a business name and address, and that information may be stored in a contact record of a contact information of the client device 1215. In still another example, the information may include a username for the second user on a social network. The information updating engine 1328 adds 312 the profile information to the first user's social graph on a social network based on the input from the user. For example, responsive to the user's input indicating that the first user wants to connect with the second user, the social network adds the second user as a connection on a social network. It should be understood that the modifications to the social graph may be a socially visible action or a private action. More specifically, in the socially visible case, if the first user updates information about a second user, for example his email address, the social network service signals that the second user is an existing user of the social network service, and the first user indicates that the second user should be added to a group of the first user on the social networks service; the method 300 updates the social graph of the first user to reflect that relationship. In the private action case, the first user may simply update a profile on the social network that the first user has about the second user. For example, instead of signaling that the system should add the second user to one of my groups on the social network service, the first user could instead signal that he only would like the profile that first user has about the second user to be updated, e.g., by adding a picture of the second user provided from the social network service, but don't actually establish a connection with the second user on the social network. In some instances, the method 300 also updates the contact information or the social graph of the first user in multiple social networks and external databases.

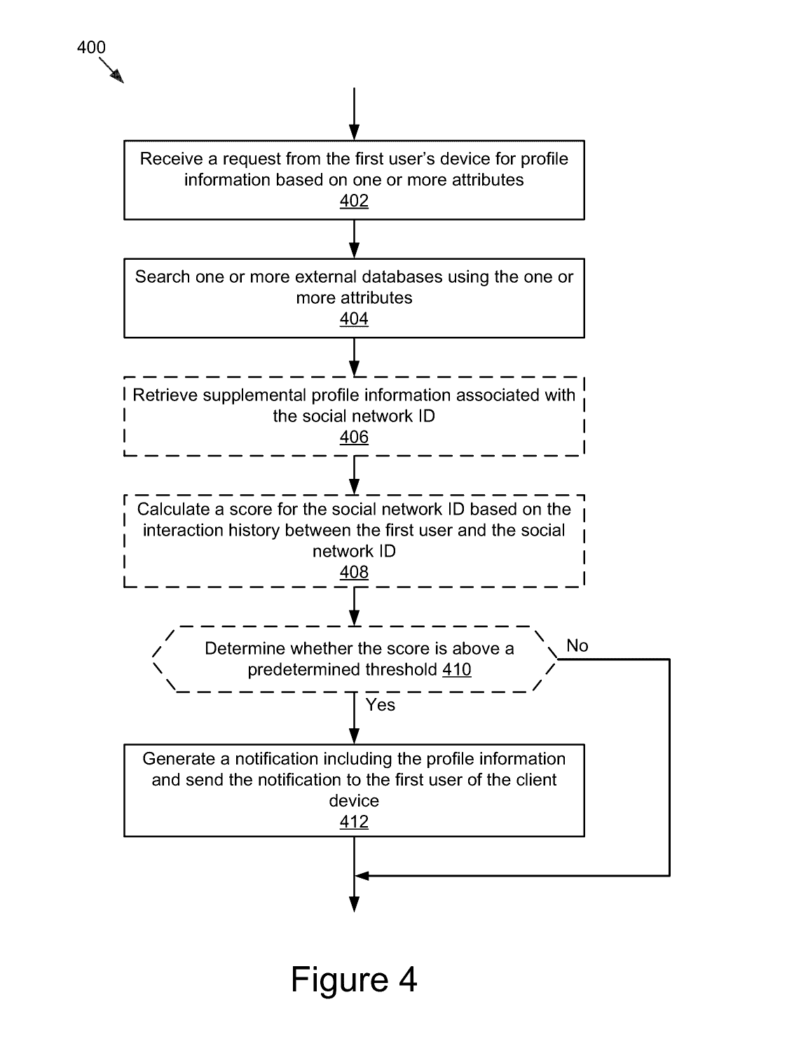

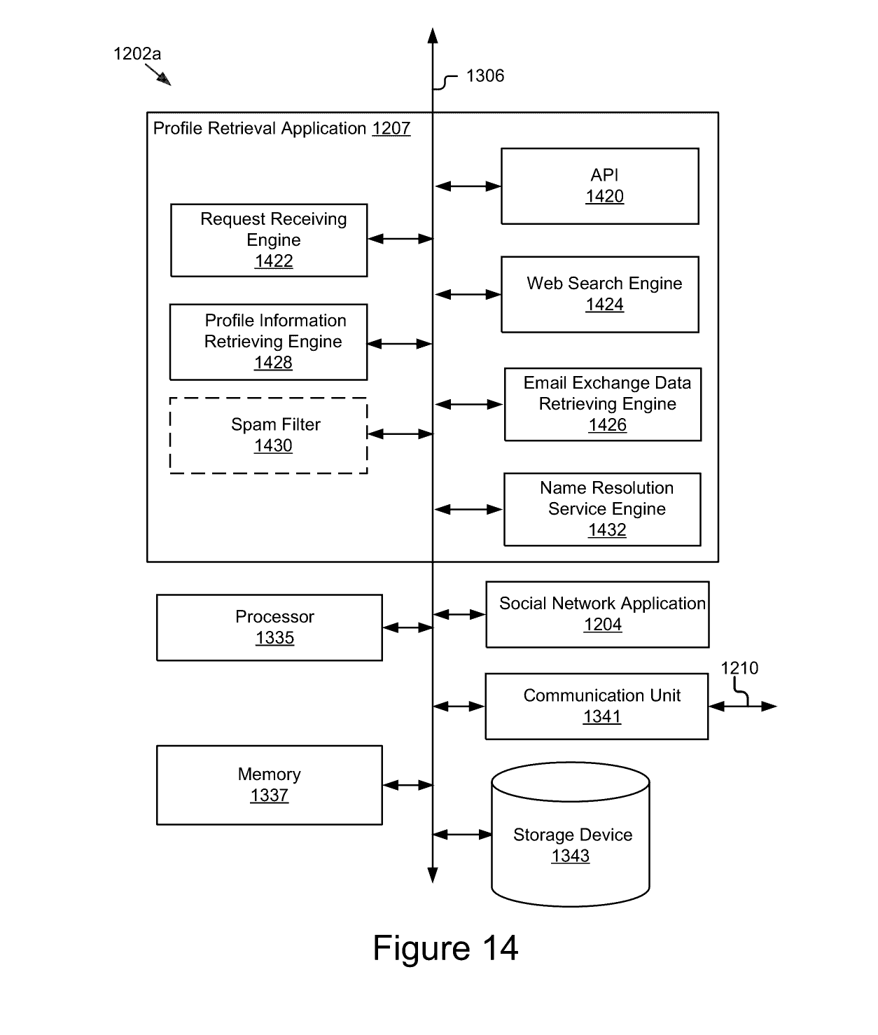

FIG. 4 is a flowchart of an example method 400 of retrieving profile information and generating a notification including the profile information. In some instances, the method 400 is performed by the profile retrieval application 1207 of the social network server 1202. The profile retrieval application 1207 includes a request receiving engine 1422, a profile information retrieving engine 1428, an API (Application Program Interface) 1420, a Web search engine 1424, an email exchange data retrieving engine 1426, a name resolution service engine 1432 and optionally a spam filter 1430. The profile retrieval application 1207 is described below in more detail with reference to FIG. 14. While the method 400 is now described below primarily in the context of searching a social network server 1202 for a social network ID as the information, it should be understood that the method 400 can be used to search other data sources for different, equally valuable, profile information, and the social network server 1202 and social network ID are merely used by way of example.

The method 400 begins with the request receiving engine 1422 of the profile retrieval application 1207 receiving 402 a request from the first user's client device 1215 for profile information based on one or more attributes. For example, the request receiving engine 1422 receives a request including a phone number as the attribute. In another example, the request receiving engine 1422 receives other calling information (start time of call, end time of call, number of calls, call from, call to, call duration, etc.) as attributes, In another example, the request receiving engine 1422 receives a request including updated or modified contact information as the attribute(s). In yet another example, the request receiving engine 1422 receives unique identifying information (e.g., phone number, name, email address, etc.) as an attribute. The unique identifying information may be derived by the profile updating application 1206 from the phone call or the modification to a contact record of a local contact information of the client device 1215.

The method 400 continues by using the received attribute(s) to search one or more data sources that are external to the client device 1215. As noted above, the data sources may include one or more databases of the social network server 1202, the profile server 1230, the web search server 1232, the email server 1236 or any third party server 1234. In some instances, the profile information is retrieved directly from these data sources using the received attribute(s). For example, the received attribute(s) may be used for a query of the profile server 1230. In another example, the received attribute(s) may be used as search terms for a search on the web search server 1232. Still more particularly, this could be a search of local business having the received attribute(s). In another example, the received attribute(s) may be used for a search of the email server for an email address of another user. In another example, the received attribute(s) may be used to search the profiles of users of the any third party server 1234. Finally, the received attribute(s) may be used for a query of the social network server 1202 and other servers for the social network ID associated with the one or more attributes. For example, the social network server 1202 may access a name resolution service and provide the received attribute(s) to determine a social network ID associated with the one or more attributes. A name resolution service is a services that retrieves of numeric values or attributes given the associated names or portions of a name. In some instances, the API 1420, web search engine 1424, email exchange data retrieving engine 1426, and name resolution service engine 1432 work together to look up the social network ID associated with the one or more attributes. It should be understood that the method 400 may perform one or different combinations of the above examples and combine the results from the different data sources as the profile information. Further in such cases, where block 404 produces the profile information, the need to perform block 406 is optional.

In some instances, retrieving the profile information is a two-step process where in block 404 unique identifying information (e.g., the social network ID) is determined, and the profile information is retrieved in block 406 using the unique identifying information. For example, the profile information retrieving engine 1428 retrieves 406 profile information associated with the social network ID. For example, the profile retrieval application 1207 may interact with the API 1420 to the social network application 1204 to look up the social network ID. In another example, the profile retrieval application 1207 may interact with the web search engine 1424 to search web pages to look up the social network ID associated with the one or more attributes. In yet another example, the profile retrieval application 1207 may interact with the email exchange data retrieving engine 1426 search the email server 1236 to look up the social network ID. To be noted, the profile retrieval application 1207 may interact with other sources or the combination of the above mentioned sources and other sources to find the social network ID. Under some circumstances, the profile retrieval application 1207 may find more than one social network IDs that are associated with the same attribute or the same group of attributes. The name resolution service engine 1432 further identifies the social network ID from other related social network IDs. It should be understood that the multiple sources may be searched for different portions of profile information related to the attribute(s). Those portions may be combined into the profile information for presentation to the user. For example, the web search server 1232 may be searched and provide the name and address of the business. The social network server 1022 may be searched and provide a social network ID for the business. The email server 1236 may be searched and provide an email address for the president of the business. This data may then be combined and presented to the user as the profile information. Moreover, this same profile information may be stored in one more of the web search server 1232, the client device 1215, the social network server 1022 and the email server 1236 as part of a profile for the first user.

In some instances, the method 400 performs a form of spam filtering or data filtering so that the user is not presented with too many notifications about profile information. In some instances these steps 408 and 410 are optional, thus steps 408 and 410 are depicted in FIG. 4 with dashed lines. In instances where 408 steps and 410 are not performed, the method 400 generates a notification and updates the profile of the first user after receiving confirmation or the profile of the first user is just automatically updated with the profile information.

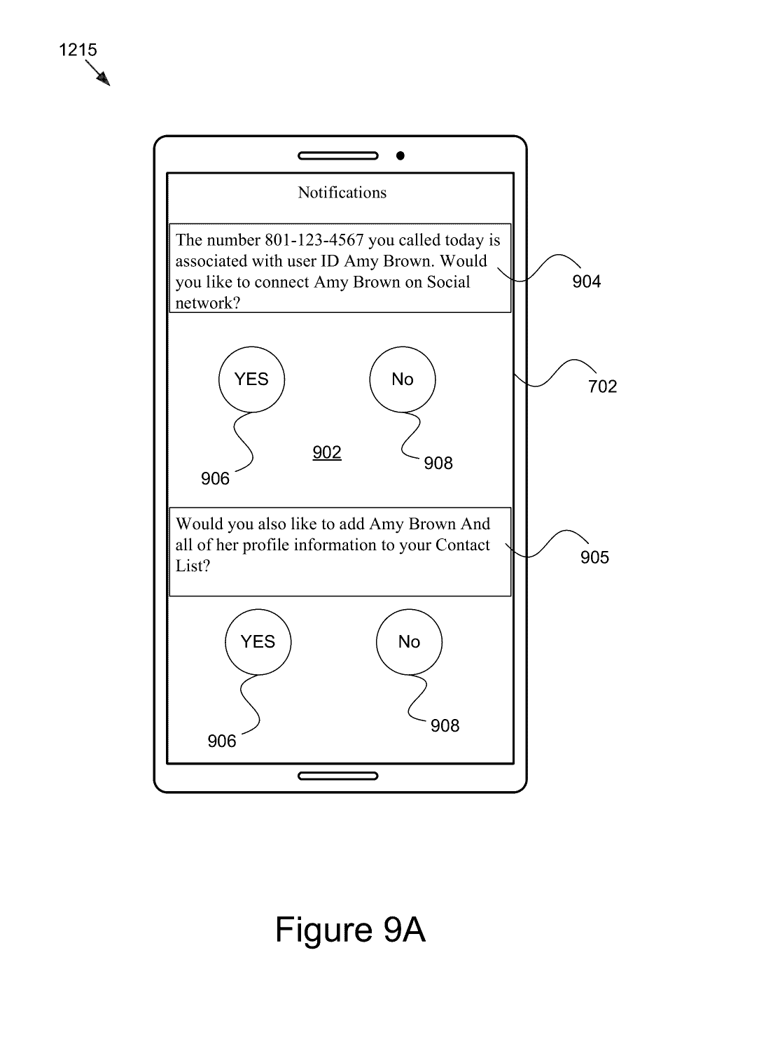

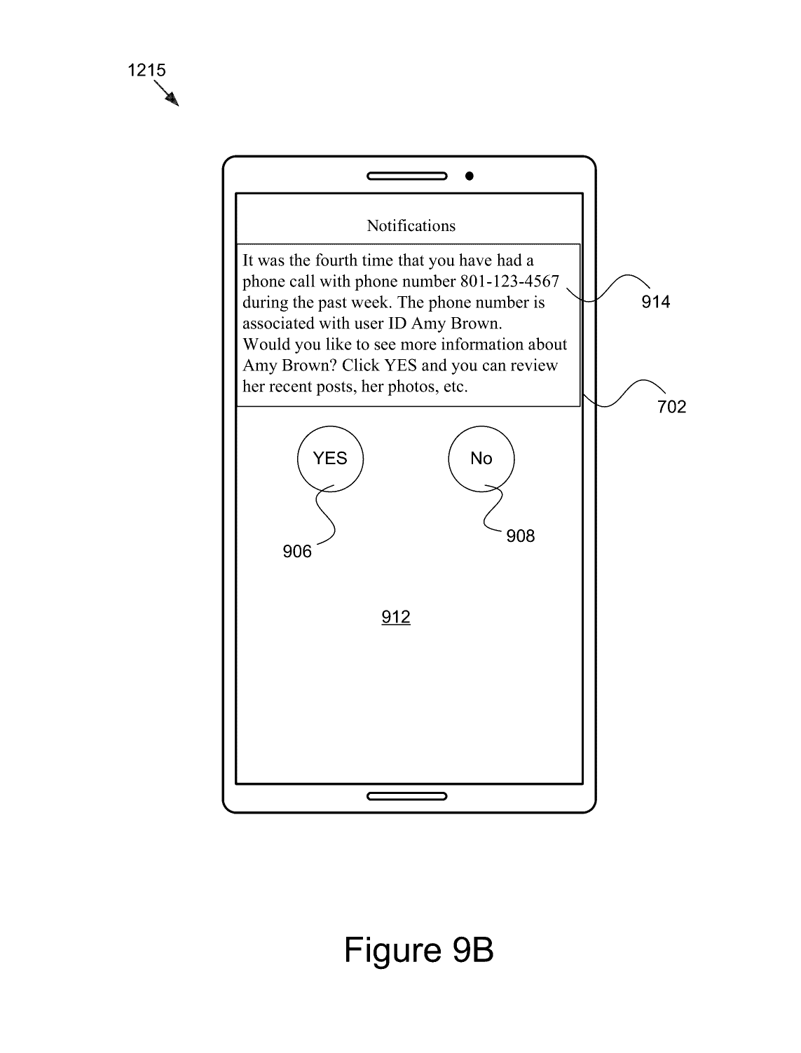

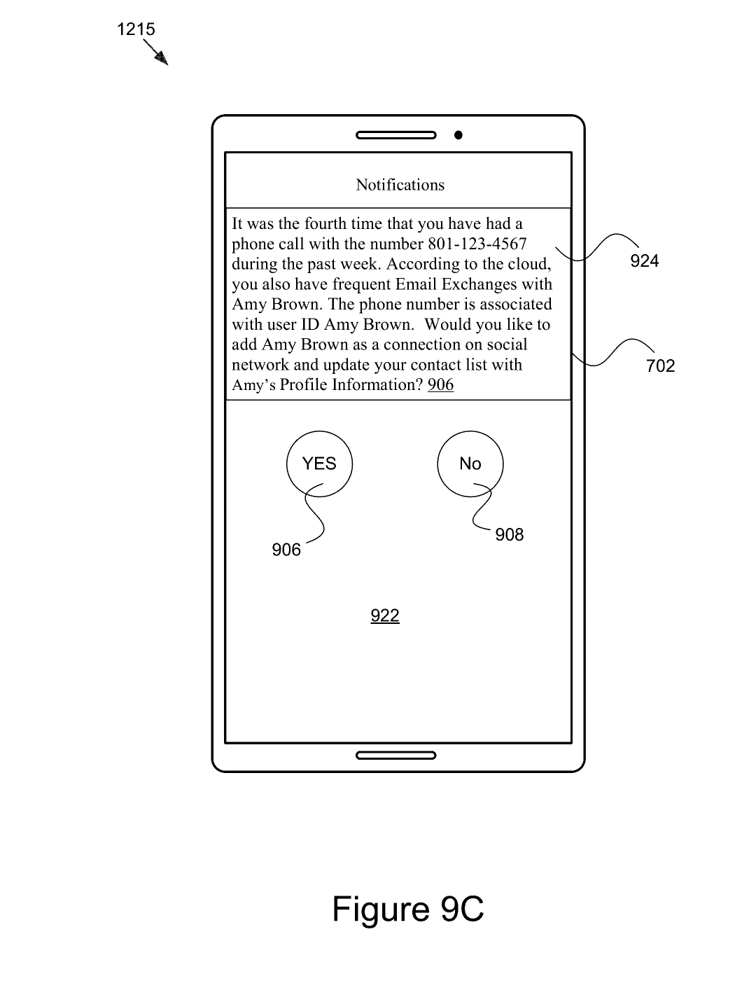

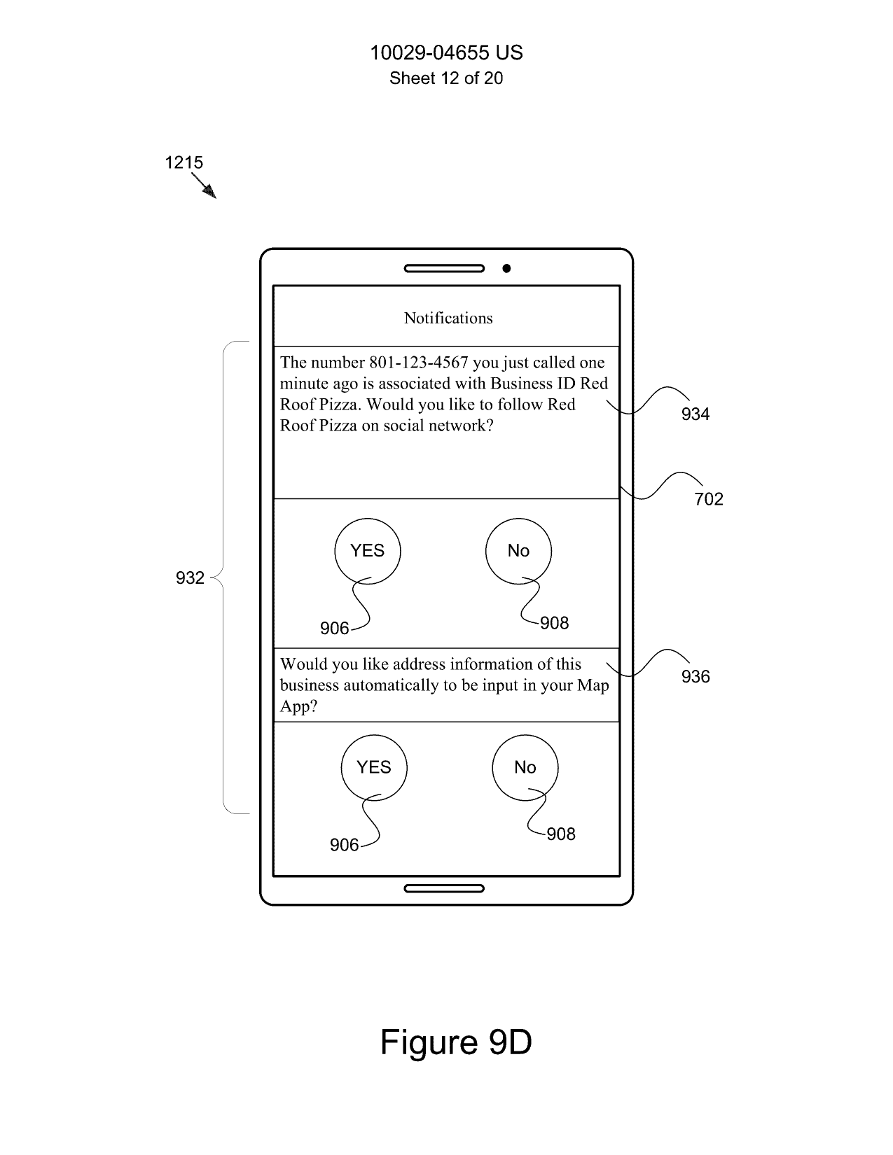

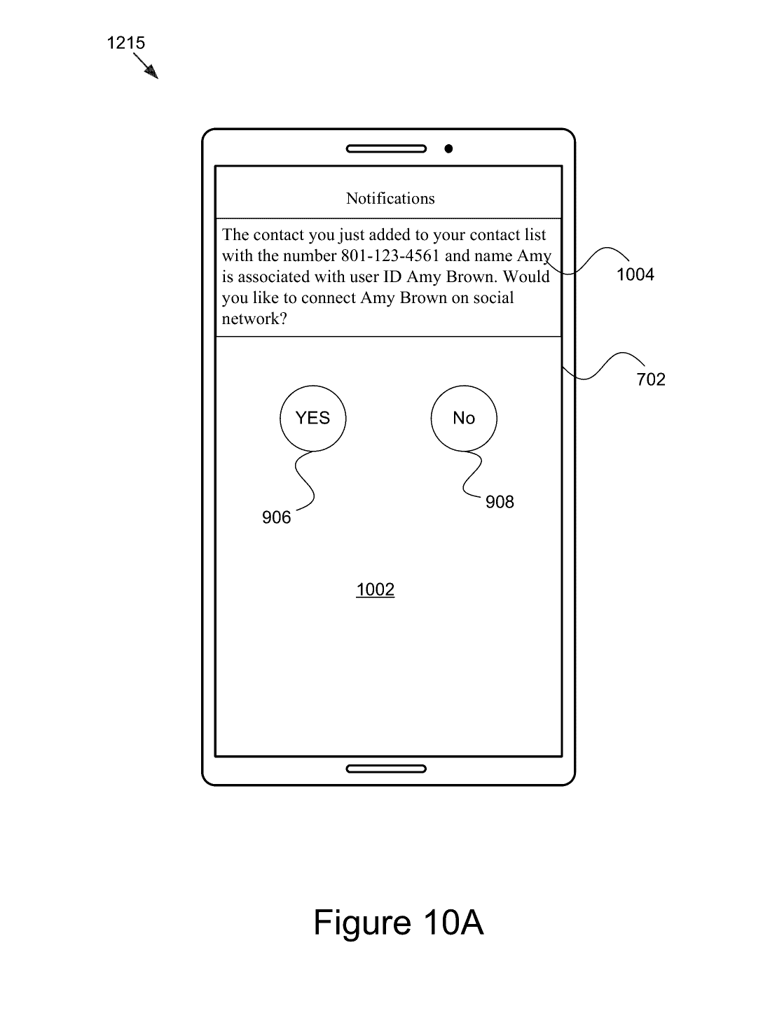

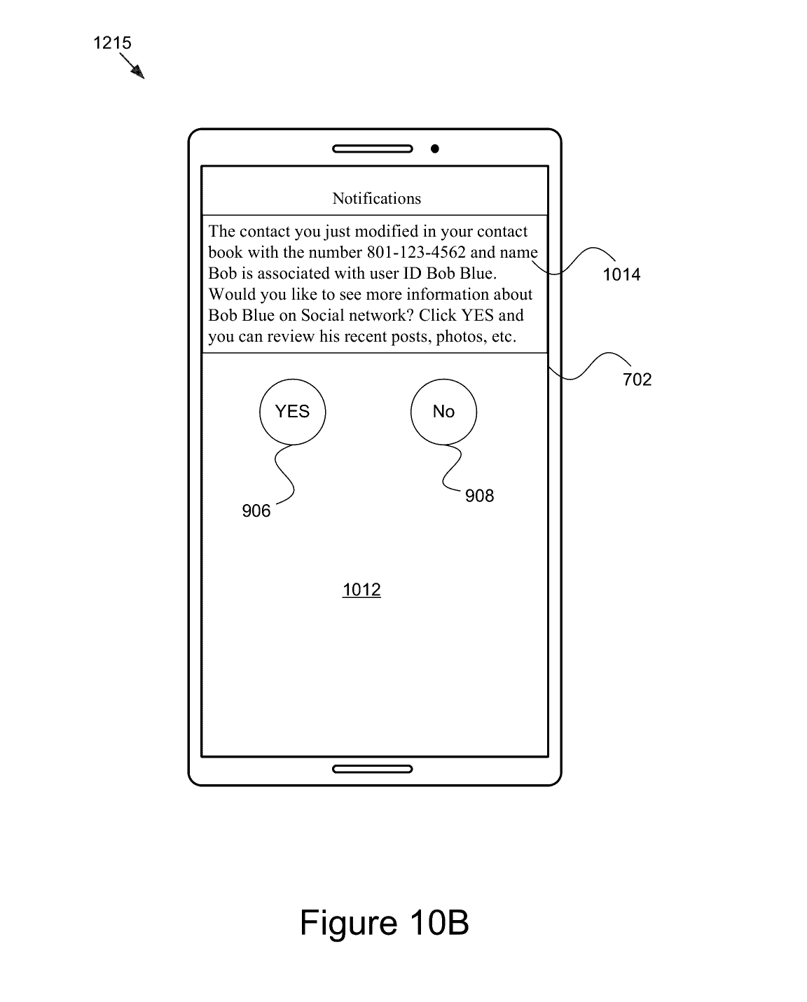

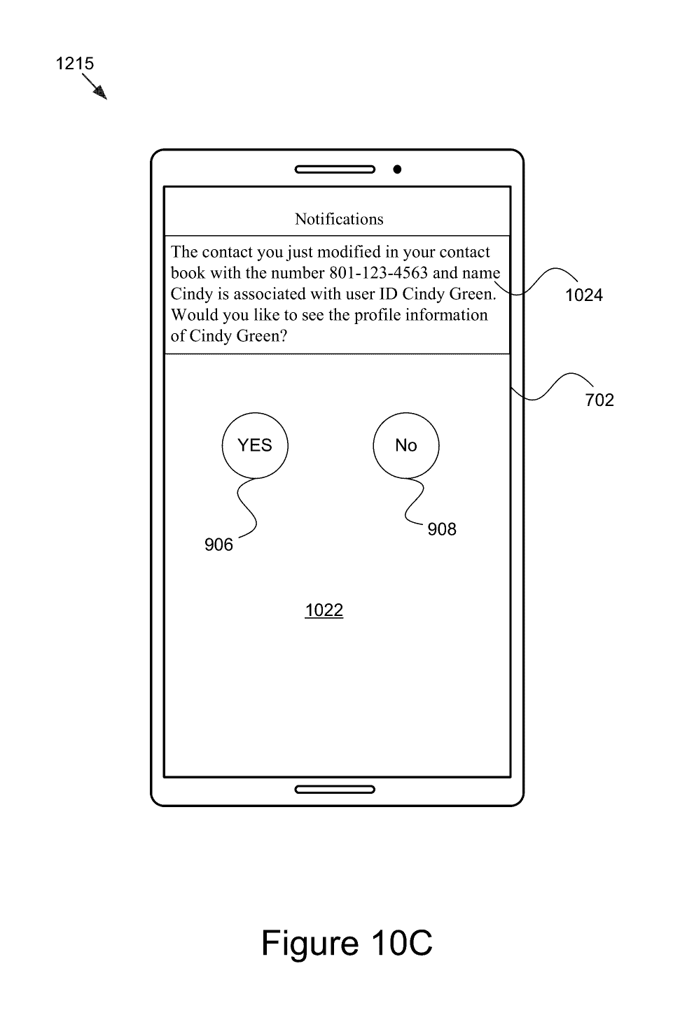

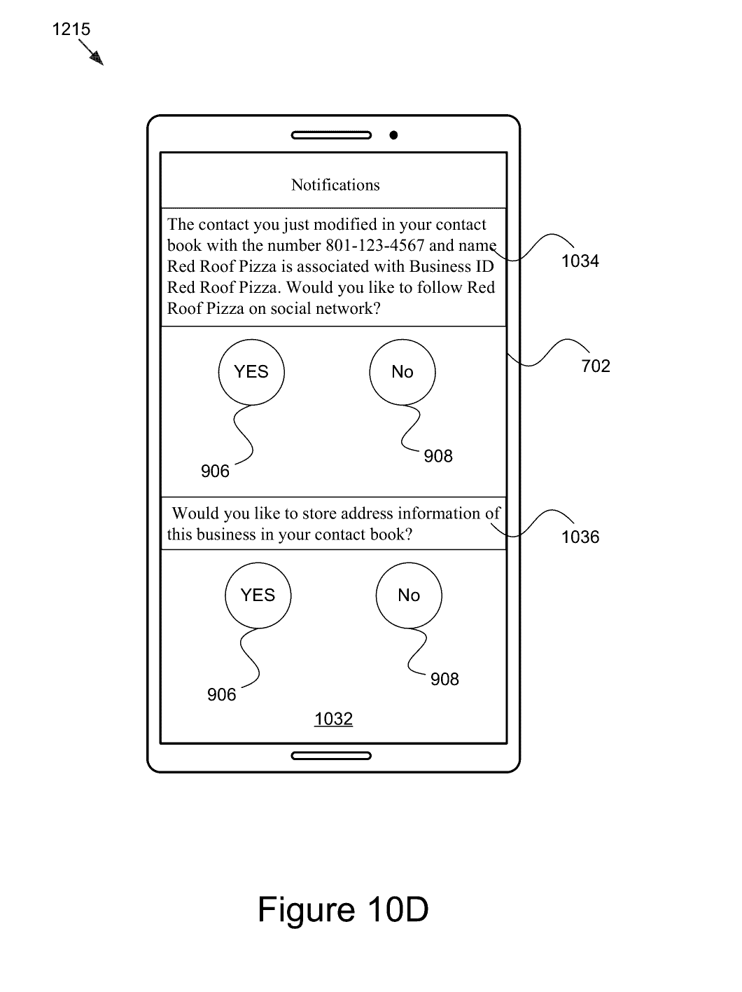

More specifically, the method 400 may determine whether to generate the notification based on various signals including social signals, calling signals, or other interaction signals. In some instances, the method 400 determines a score using one or a combination of the social signals, calling signals and other interaction signals. In some instances, the spam filter 1430 of the profile retrieval application 1207 calculates 408 a score for the social network ID based on the interaction history between the first user and the user corresponding to the social network ID. The score may be calculated based on frequency and other factors. For example, when the contact information related activity is a phone call, and this is the third phone call between the first user (i.e., the user of the client device 1215) and the second user associated with this phone number during a predetermined amount of time (e.g., the past week), then the score for this social network ID is higher than if there were only two or fewer calls between the two users. The spam filter 1430 determines 410 whether the score calculated in block 408 is above a predetermined threshold. If the score is not above the predetermined threshold, then the method 400 continues without performing block 412. The purpose of blocks 408 and 410 is to ensure that every notification generated and presented to the first user is interesting to the first user to a certain degree. This also prevents the first user from having a bad experience in which she consistently receives notifications that are not that useful to her. Other factors may also be taken into consideration in calculating the score, for example, email exchange frequency, whether the second user is already a contact in the contact information, etc. In some instances, the rules may be applied to determine whether to generate a notification. For example, the rules may include: 1) the user is in my contacts list, and this is at least the first time the user has been called; 2) the user is in another contacts list, and this is at least the third time the user has been called; 3) the user is in one of my defined groups on the social network, and this is at least the third time the user has been called; 4) the phone numbers in my call history and this is at least the 5^{th} time the user has been called. It should be understood, that these rules could also be translated into a calculated score corresponding threshold. If the determined score is above the predetermined threshold, the method 400 continues to block 412. The profile retrieval application 1207 generates 412 a notification including the profile information and sends the notification to the first user of the client device 1215. The example notifications are describe in more detail below with reference to FIGS. 9A-9E and 10A-10E.

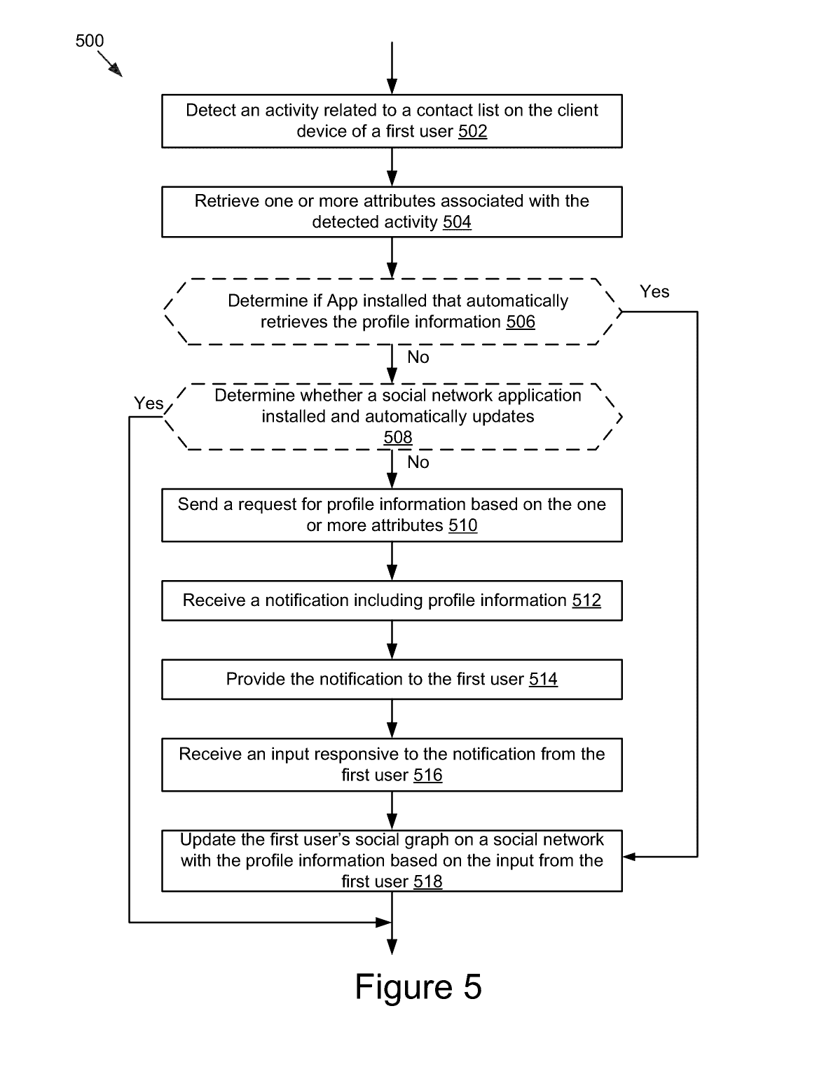

FIG. 5 shows another example method 500 for updating user's social graph with the retrieved supplement profile information. The method 500 is advantageous because it cooperates with a phone dialer application 1330 and other applications 1332 operational on the client device 1215. Again, this instance of the method 500 is described in the context of detecting an action or activity related to a contact information and in response retrieving profile information and using it to update the social graph of the user. It should be understood that these examples of profile information and updating action are merely one example from others noted above and the method 500 of FIG. 5 is equally applicable for other types of profile information and updating actions.

The activity detecting engine 1320 detects 502 an activity performed by a first user on the client device 1215 (e.g., a mobile computing device). For example, the activity can be a call on the client device 1215 or a modification of a contact record in the contact information of the client device 1215. The attribute extraction engine 1322 retrieves 504 one or more attributes associated with the detected activity. For example, when there is a call on the client device 1215, the attribute can be the phone number; or when there is a modification of a contact record in the contact information, the attributes may be the data and fields of the modified contact record. In some instances, the profile updating application 1206 may store the profile information retrieved (e.g., photo, email address, etc.) to a local contact record in the contact information of the client device 1215.

In some instances, the method 500 determines whether some of the operations normally performed by the updating application 1206 have already been performed by other components or applications of the client device 1215. For example, the client device 1215 may include other applications that retrieve profile information or update profiles external or remote to the client device 1215. In such cases, the method 500 is optimized so that the updating application the 1206 does not repeat actions that it would normally perform but have already been performed. The profile updating application 1206 determines 506 whether the client device 1215 has an installed application that automatically retrieves the profile information. For example, some pre-installed dialers of smart phone automatically retrieve the profile information from the cloud. In this case, it would be redundant to look up and retrieve the profile information for the user. If the result of the determination in block 506 is that the client device 1215 does have an application installed that automatically retrieves the profile information, then the method 500 continues to block 518 as will be described below. On the other hand, if the result of the determination in block 506 is that the client device 1215 does not have an application installed that automatically retrieves the profile information, then the method 500 proceeds to step 508, where the profile updating application 1206 determines whether a social network is installed on the client device 1215 and automatically updates the social network with the profile information associated with the one or more attributes. Blocks 506 and 508 are optional and therefore depicted in FIG. 5 with dash lines.

If block 508 determines that the social network application of the first user is set to automatically update, then profile updating application 1206 does not perform blocks 510 to 518, and the method 500 continues after block 518. On the other hand, if block 508 determines that the social network application does not exist or is not set to automatically update, the profile updating application 1206 sends 510 a request for profile information based on the one or more attributes and receives 512 a notification including the profile information. The notification engine 1326 provides 514 a notification to the first user of the client device 1215. The notification can include the various information and take various formats as has been described above. The information updating engine 1328 receives 516 an input responsive to the notification from the first user. Responsive to the input being a confirmation that an updating action should be taken, the information updating engine 1328 updates 518 the first user's social graph on a social network with the profile information based on the input from the user. For example, responsive to the user's input indicating that the first user wants to connect with the second user, the social network adds the other users as a connection on a social network. In some instances, the information updating engine 1328 also updates the contact information or the social graph of the first user in multiple social networks and external databases.

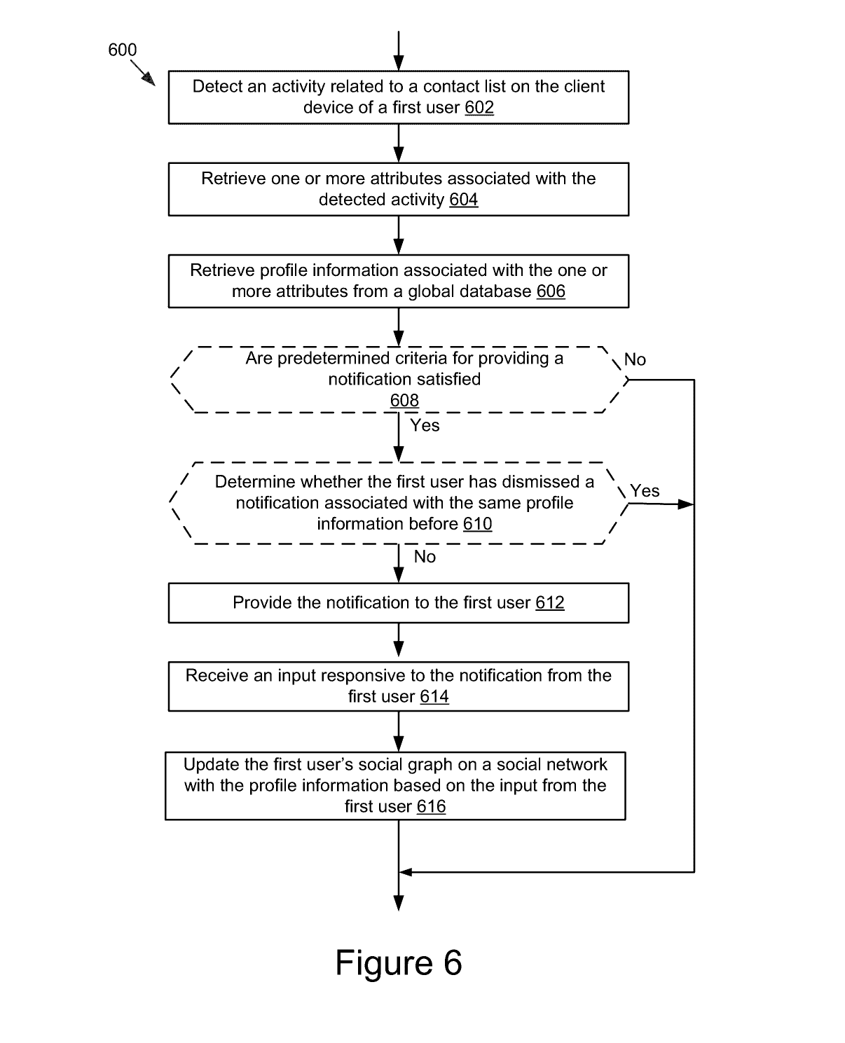

FIG. 6 shows another example method 600 for updating user's social graph with the retrieved supplement profile information. The method 600 is advantageous because it adds conditions for presenting a notification will to the user. This is advantageous because it minimizes notification spam. Again, this instance of the method 600 is described in the context of detecting an action or activity related to a contact information and in response retrieving profile information and using it to update the social graph of the user. It should be understood that these examples of profile information and updating action are merely one example from others noted above and the method 600 of FIG. 6 is equally applicable for other types of profile information and updating actions.

The activity detecting engine 1320 detects 602 an activity related to a contact information on the client device 1215. The attribute extraction engine 1322 retrieves 604 one or more attributes associated with the detected activity. Responsive to retrieving the one or more attributes, the profile retrieving engine 1324 retrieves 606 the profile information associated with the one or more attributes from a global database. For example, the profile updating application 1206 looks up for the social network ID associated with these attributes and retrieves the profile information of the social network ID.

In some instance, the profile updating application 1206 determines 608 whether to provide a notification based on predetermined criteria being satisfied. For example, this determination can be based on the interaction history between the first user and the second user. When the interaction history shows that the first user has great potential to be interested in the profile information of the second user, the notification may be provided. The predetermined criteria may include multiple factors, e.g., frequency of the calls, frequency of the email exchange, etc. If the predetermined criteria for providing a notification are determined not to be satisfied in block 608, the method 600 does not provide a notification and does not update any profiles and continues after block 616. On the other hand, if the predetermined criteria for providing a notification are determined to be satisfied in block 608, the method 600 proceeds to block 610, where the profile updating application 1206 determines whether the first user has dismissed a previously presented notification associated with the same profile information. For example, the client device 1215 can store a blacklist that shows every notification that the user has dismissed before and the profile updating application 1206 checks whether the notification to be provided associates with the same profile information in the black list. It should be understood that it could be other numbers of dismissals greater that one. For example, the notification may be presented up to three times and after that it will be inferred that the notification will not be presented any more. In other examples, the notification may include two dismissal button, one for only this instance and another for all future instances, this was explicit feedback from the user may be used in future determination steps. In some instances, the black list can be stored in a per-device way, but not in a per-account way. If the notification matches any of the dismissed notifications in the blacklist, meaning the first user of the client device does not interested in this notification. To improve the user experience, the method 600 continues after block 616 and won't annoy the first user with the same notification once again. On the other hand, if the first user has not dismissed a previously presented notification associated with the same profile information, then the method 600 proceeds to block 612.

The notification engine 1326 provides 612 the notification to the first user of the client device. The information updating engine 1328 receives 614 an input responsive to the notification from the first user. For example, the input may indicate that the first user want to connect with the second user on social network. In another example, the input may indicate that the user wants to store the profile information of the second user as a contact in the contact information on the client device. The information updating engine 1328 updates 616 the first user's social graph on a social network with the profile information based on the input from the user. In some instances, the information updating engine 1328 also updates the contact information or the social graph of the first user in multiple social networks and external databases. For example, the External database can be a database directed to career connections, a database centered on local business or other databases of general interest or a specific focus.

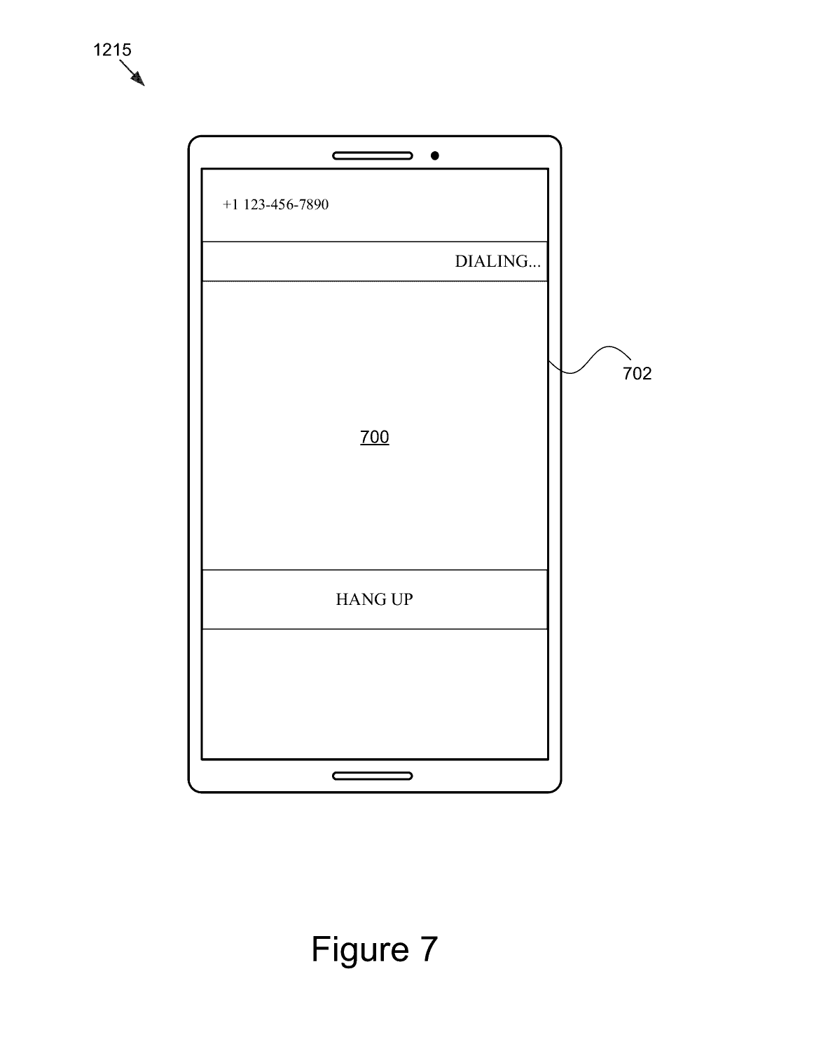

FIG. 7 is a graphic representation of example user interface 700 showing actions or activities that trigger retrieval of profile information and updating of a user's a profile. FIG. 7 is a graphic representation of example user interface 700 for dialing a phone number or making a phone call. In this example, the majority of the screen 702 is blank because this client device 1215, in this case, a smart phone, does not have any surrounding information about this phone number. It should be understood that it would be similar in an incoming phone call scenario, i.e., the majority of the screen 702 would be blank because there is no other information to show if this phone number is not in the contact information, no matter how many times of interactions prior to this call.

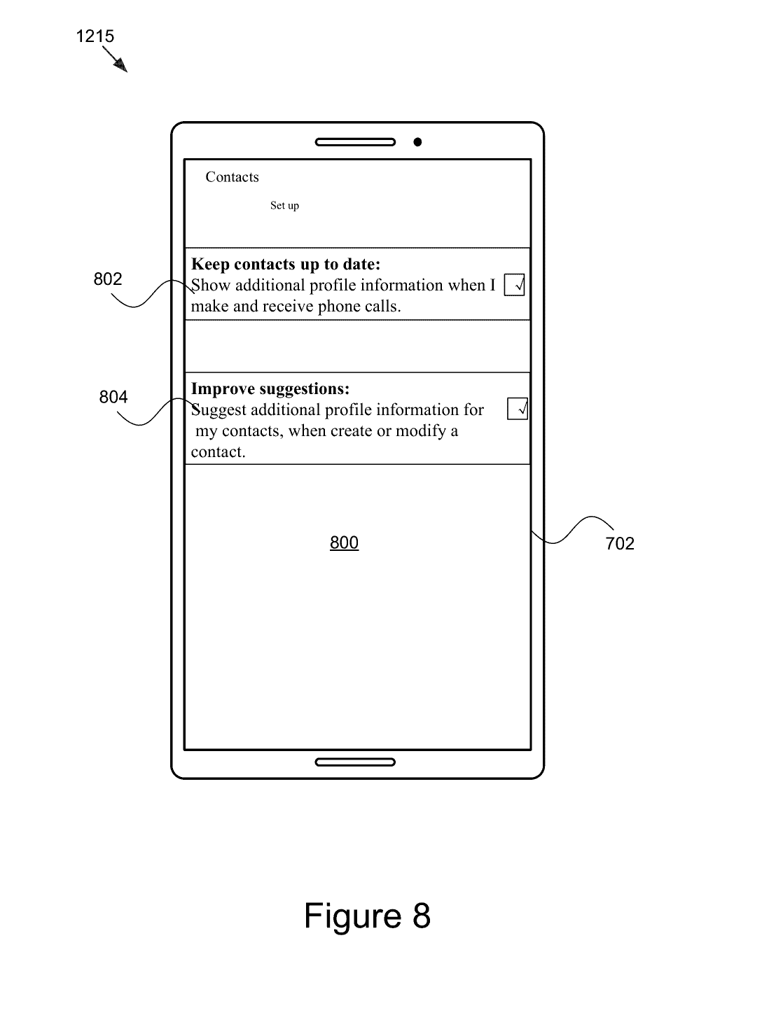

FIG. 8 is a graphic representation of example user interface 800 for initializing the operation of the profile updating application 1206. As shown in FIG. 8, the user interface 800 allows the user to select functions of local updating (e.g., “Keep contacts up to date”) and automatic improvement (e.g., “Improve suggestions”) of the profile updating application 1206. The local updating function shown by a “Keep contacts up to date” area 802 represents the function of showing profile information when the first user makes or receives a phone call. A notification is generated and the first user my decide to add social network profile information and information about connections to his local contact book, including phone numbers, profile photos and email addresses, etc. The area 802 provides a selectable check box that toggles between enabling and disabling this function. When selected, the local updating function will retrieve profile information as has been described above and store that profile information locally in the client device 1215, for example, in the contact information. The automatic improvement function shown by an “Improve suggestions” area 804 represents the function of using the profile information to improve/update the contact information of the first user on the client device 1215 in response to creation or modification of a new contact record in the contact information. The contact information of the first user is updated with information from on external databases or adding connections to your social network using the profile information. For example, the social graph of the user may be augmented from suggestions based on who the first user communicates with most often on this device 1215. The area 804 provides a selectable check box that toggles between enabling and disabling this function. These functions can be selected during the initial installation or modified later, and the default values of these functions can be enabled.

FIGS. 9A-9D are graphic representations of example user interfaces 902, 912, 922 and 932 for notifications of the present disclosure. The example notifications are for presenting profile information in response to a phone call. These notifications are triggered by a phone call which has a phone number not in the contact information of the user of the client device 1215. It should be understood that the functionality described below in FIGS. 9A-9D may be part of any of the methods described above with reference to FIGS. 1-6 and the presentation of notifications.

FIG. 9A is a graphic representation of the example user interface 902. The user interface 902 includes a notification 904 message/question and a pair of buttons 906, 908 for performing or rejecting the action proposed in the notification 904. The notification 904 presents information to the user indicating that “The number 801-123-4567 you called today is associated with user ID Amy Brown. Would you like to connect Amy Brown on Social network?” This notification 904 includes the social network ID associated with the attribute (the phone number) and offered further action that the system will take automatically responsive to user selection of the yes button 906. The user interface 902 also includes a second notification 905 message/question and a pair of buttons 906, 908 for performing or rejecting the action proposed in the notification 905. The second notification 905 presents a question to the first user as to whether he “Would like to add Amy Brown and all of her Profile Information to your Contacts List?” It should be understood that in other examples, the user interface 902 may only present one of the two notifications 905, 904 or the notifications 905, 904 in different order, appearance or format. It should be understood that the present disclosure allows information from different servers to be used to update the client device 1215 or other servers. Sometimes there is profile information that you might want to add to your contact information (e.g., address book), but you don't have a way to connect with this person on a social network. For example, the profile information may come from the search server, but the second user is not on the social network server.

FIG. 9B is a graphic representation of another example user interface 912. The user interface 912 includes a notification 914 message/question and a pair of buttons 906, 908 for performing or rejecting the action proposed in the notification 914. The notification 904 presents information to the user indicating that “It was the fourth time that you have had a phone call with the number 801-123-4567 during the past week. The phone number is associated with user ID Amy Brown. Would you like to see more information about Amy Brown? Click YES and you can review her recent posts, her photos, etc.” This notification 914 includes the social network ID associated with the phone number and interaction history with this phone number, and offers more profile information about this social network ID. This notification 914 is advantageous because it provides more information before the first user has to decide whether to add the second user associated with the social network ID as a connection. The interaction history also helps the first user to make decision whether to add the second user as a connection. Additionally, the notification 914 is only presented after a predetermined number of calls between the client device 1215 and the phone number

FIG. 9C is a graphic representation of another example user interface 922. The user interface 922 includes a notification message 924 including a question and a pair of buttons 906, 908 for performing or rejecting the action proposed in the notification 924. The notification 924 presents information to the user indicating that “It was the fourth time that you have had a phone call with the number 801-123-4567 during the past week. According to the cloud, you also have frequent email exchanges with Amy Brown. The phone number is associated with user ID Amy Brown. Would you like to add Amy Brown as a connection on social network and update your contact information with Amy's Profile Information?” This notification 906 includes the social network ID associated with the phone number and phone call and email exchange history with this social network ID. The notification could include even more detailed information about their interactions in some instances. The email history can be really useful for the first user to determine whether to connect with the second user on a social network. This notification 906 also provides the actions that the first user can take, which is “add Amy Brown as a connection on social network and update your contact information with Amy's Profile Information.” In some instances, when the first user of the client device 1215 selected not to keep contacts up to date, the application 1206 incorporates the query regarding whether the first user wants to add the profile information to the local contact information. This is advantageous because even for the users who do not want the application automatically update the local contact information, they still have another convenient opportunity to store richer information about a contact item in their local contact information.

FIG. 9D is a graphic representation of another example user interface 932 showing a two part notification. The user interface 932 includes a plurality of notification messages 934, 936 and associated pairs of buttons 906, 908 for performing or rejecting the action proposed in each respective notification message 934, 936. The first notification 934 is “The number 801-123-4567 you just called one minute ago is associated with Business ID Red Roof Pizza. Would you like to follow Red Roof Pizza on social network?” The second notification 936 is “Would you like address information of this business automatically to be input in your Map App?” This example user interface 932 illustrates that any number of notifications may be presented in the same interface each with a respective action or no action. The first notification 934 is related to a business, includes the business ID and offers the option to follow the business on social network. The second notification 936 is also related to the same business in the first notification 934 and offers to store the address of this business in the Map application of the client device 1215. This notification 908 is advantageous because it makes it easier for the first user to follow a business in which he or she is interested. Further, many use the Map App on their phone as a GPS, so it is especially advantageous if the address of the business (maybe a restaurant) can be input in the Map App without the first user having to manually input the address.

FIGS. 10A-10D are a graphic representations of example user interfaces 1002, 1012, 1022 and 1032 for presenting profile information in response to modification of a contact record in the contact information of the client device 1215.

FIG. 10A is a graphic representation of the example user interface 1002. The user interface 1002 includes a notification message 1004 and a pair of buttons 906, 908 for performing or rejecting the action proposed in the notification 1004. The notification 1004 presents information to the user indicating that “The contact you just added to your contact information with the number 801-123-4561 and name Amy is associated with user ID Amy Brown. Would you like to connect with Amy Brown on social network?” The notification 1002 is provided in the scenario that the first user adds a new contact information in the contact information of the client device 1215. The system used the modified contact to search the social network and locate the user ID Amy Brown. This notification 1002 includes the social network ID associated with the attributes and asks for confirmation to confirm the automated action of adding a connection to the second user in the social network.

FIG. 10B is a graphic representation of the example user interface 1012. The user interface 1012 includes a notification message 1014 and a pair of buttons 906, 908 for performing or rejecting the action proposed in the notification 1014. The notification 1014 presents information to the user indicating that “The contact you just modified in your contact book with the number 801-123-4562 and name Bob is associated with user ID Bob Blue. Would you like to see more information about Bob Blue on Social network? Click YES and you can review his recent posts, photos, etc.” This notification 1014 includes the social network ID associated with the phone number and offers more profile information about this social network ID. This notification 1014 is advantageous because it provides more information before the first user has to decide whether to add the second user associated with the social network ID as a connection.

FIG. 10C is a graphic representation of the example user interface 1022. The user interface 1022 includes a notification message 1024 and a pair of buttons 906, 908 for performing or rejecting the action proposed in the notification 1024. The notification 1024 presents information to the user indicating that “The contact you just modified in your contact book with the number 801-123-4563 and name Cindy is associated with user ID Cindy Green. Would you like to see the profile information of Cindy Green?” This notification 1022 offers to provide more profile information associated with the second user and it helps the first user to identify who the second user is based on the profile information.

FIG. 10D is a graphic representation of the example user interface 1032. The user interface 1032 includes a plurality of notification messages 1034, 1036 and associated pairs of buttons 906, 908 for performing or rejecting the action proposed in each respective notification message 1034, 1036. The first notification 1034 is “that “The contact you just modified in your contact book with the number 801-123-4567 and name Red Roof Pizza is associated with Business ID Red Roof Pizza. Would you like to follow Red Roof Pizza on social network?” The second notification 1036 is “Would you like to store address information of this business in your contact book?” This example user interface 1032 illustrates that any number of notifications may be presented in the same interface each with a respective action or no action. The first notification 1034 is related to a business, includes the business ID and offers the option to follow the business on social network. The second notification 1036 is also related to the same business in the first notification 1034 and offers to store the address of this business in the contact book of the client device 1215. This scenario illustrates that modified contact information may be used as attributes that can be used to look up the social network ID and secure contact information.

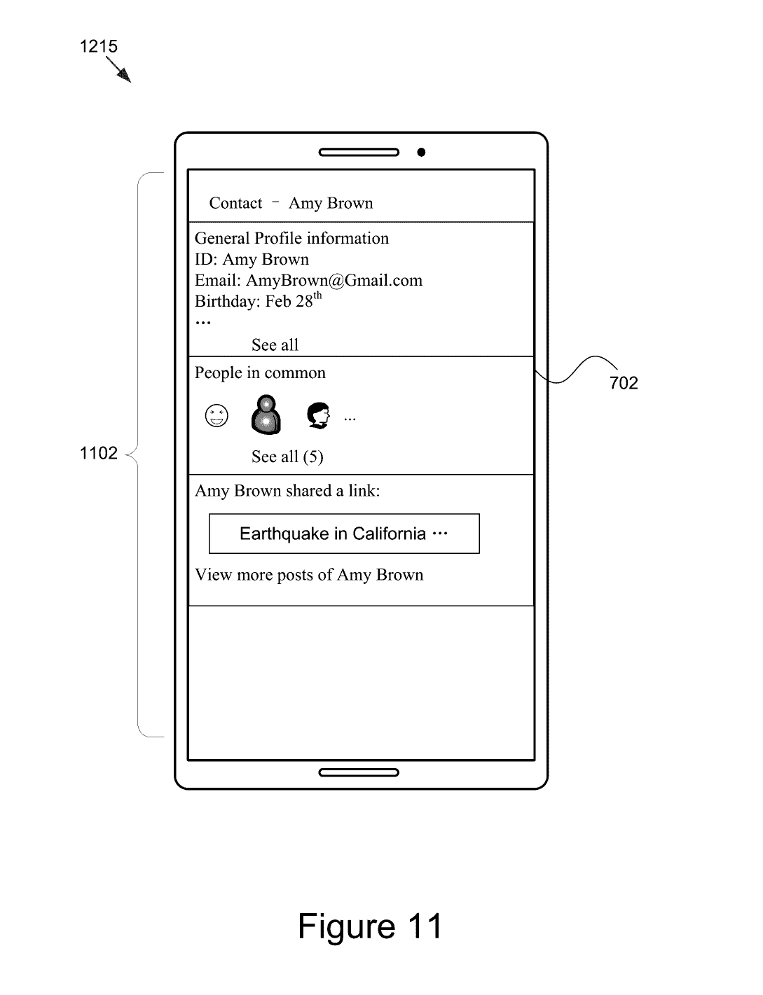

FIG. 11 is a graphic representation of example user interface 1102 of a contact including profile information. As shown in FIG. 11, the profile information of the second user is added to the contact record for the second user. The profile information may include the following: an age, birthday, geographical location, email address, profile photo, phone number, work information, education, browsed content, registered applications, people in common on the social network, groups joined by a user associated with the number. However, the profile information advantageously includes the people in common because it is much easier for the first user to identify who the second user is based on the people they both know, or helps the first user recall how she or he met the second user. In other instances, the profile information can also include the second user's posts on a social network or links to other actions of the second user on the social network.

FIG. 12 is a block diagram illustrating an example system 1200 for updating user's social graph with retrieved profile information. The illustrated description of the system 1200 includes client devices 1215a . . . 1215n that are accessed by uses 1125a . . . 1125n, one or more servers 1202a . . . 1202n, a profile server 1230, an email server 1236, a web search server 1232 and one or more third-party servers 1234a . . . 1234n. In the illustrated implementation, these entities of the system 1200 are communicatively coupled via a network 1205. In FIG. 12 and the remaining figures, a letter after a reference number, for example “1215a” is a reference to the element having that particular reference number. A reference number in the text without a following letter, for example “1215,” is a general reference to any or all instances of the element bearing that reference number.

The network 1205 may be a conventional type of network, wired or wireless, and may have any number of configurations for example a star configuration, token ring configuration or other configurations. Furthermore, the network 1205 may comprise a local area network (LAN), a wide area network (WAN) (e.g. the Internet), and/or any other interconnected data path across which multiple devices may communicate. In some instances, the network 1205 may be a peer-to-peer network. The network 1205 may also be coupled to or includes portions of a telecommunications network for sending data in variety of different communication protocols. In some other instances, the network 1205 includes Bluetooth communication networks or a cellular communication network for sending and receiving data for example via SMS/MMS, hypertext transfer protocol (HTTP), direct data connection, WAP, e-mail or another suitable type of electronic communication. While only one network 1205 is illustrated, any number of networks may be coupled to the above mentioned entities.

The client devices 1215a, 1215n in FIG. 1 are used by way of example. Although only two client devices 1215 are illustrated, the technology applies to a system architecture having one or more client devices 1215. The users 1225a, 1225n interact with the client devices 1215a, 1215n respectively. The client devices 1215a, 1215n are coupled to the network 1205 via signal lines 1214a, 1214n respectively. The client device 1215 can be any computing device that includes a memory and a processor. In some specific instances, the client device 1215 is a mobile computing device, e.g., a mobile phone or smart phone. For example, the client device 1215 can be a laptop computer, a desktop computer, a tablet computer, a mobile telephone, a personal digital assistant, a mobile email device, a portable game player, a portable music player, a television with one or more processors embedded therein or coupled thereto or any other electronic device capable of accessing the network 1205, etc.

In some instances, the client device 1215 includes a profile updating application 1206. The profile updating application 1206 can be code and routines stored in the memory and executed by the processor of the client device 1215. The profile updating application 1206 includes modules or routines that can retrieve profile information hosted by the servers 1202, 1230, 1236, 1232 and 1234 and can present the retrieved profile information on a display device 1345 of the client device 1215a. In some other instances, the profile updating application 1206 retrieves and presents profile information hosted by the client device 1215 itself. The term profile information includes any document or information resource that comprises textual elements, non-textual elements (for example, static images, animated images, audio, video, etc.), interactive elements (for example, games, buttons, hyperlinks, etc.), scripts (for example, JavaScript, code implementing Ajax techniques, etc.), metadata, etc.

In some instances (not shown), the profile updating application 1206 may also be operable on the social network server 1202, which is coupled to the network 1205 via signal line 1210. The social network server 1202 can be a hardware server or servers that include a processor, a memory and network communication capabilities. The social network server 1202 sends and receives data to and from one or more of the client devices 1215a, 1215n and/or other servers 1202 via the network 1205. In some instances, the social network server 1202 can be an implementation making use of Representational State Transfer (REST) principles and supporting data representation in JavaScript Object Notation (JSON) format. In other instances, the social network server 1202 can include multiple instances and each instance can include its own directory structure, configuration and deployed applications. For example, a test instance on the social network server 1202 can be for internal quality assurance and trouble shooting and a production instance on the social network server 1202 can be for generating a response to external requests.

In some instances, the social network server 1202 includes a profile retrieval application 1207 as a standalone application as shown in FIG. 12 or in some instances the profile retrieval application 1207 may be part of the profile updating application 1206. The profile retrieval application 1207 includes software including routines that, when executed by a processor (not pictured), retrieve the social network ID associated with certain attributes and generates a notification including the profile information associated with the social network ID. The profile retrieval application 1207 can be stored on a non-transitory memory associated with the social network server 1202. The profile retrieval application 1207 is dedicated to generating and providing profile information for display to the user. In some instances, the profile retrieval application 1207 determines the data source from which to retrieve the profile information on a request basis by calculating a score to determine the social network with which the user has more interaction. For example, when the score is above than a predetermined threshold, which indicated enough confidence that the user will be interested in the profile information from that data source, the profile retrieval application 1207 retrieves the profile information and generates a notification. Otherwise, the profile retrieval application 1207 does not retrieve the profile information and does not generate the notification. The profile retrieval application 1207 is described in more detail in FIG. 14.

The email server 1236 hosts an electronic mail service and stores email interaction information and email profile information. The email server 1236 provides the email profile and email interaction information responsive to requests from the profile retrieval application 1207 or the profile updating application 1206. For example, the email server 1236 provides information related to a second user's email address, email exchange between the users, etc. The email server 1236 is coupled for communication and cooperation with the client devices 1215 and other servers 1202, 1230, 1232 and 1234 by the network 1205.

The profile server 1230 stores and provides profile information for various system and cooperates with those systems to receive, send and verify profile information. The profile server 1230 provides or stores profile information responsive to requests from the profile retrieval application 1207 or the profile updating application 1206. The profile server 1230 is coupled for communication and cooperation with the client devices 1215 and other servers 1202, 1232, 1234 and 1236 by the network 1205.

The web search server 1232 provides access to web pages and other information available on the Internet. The web search server 1232 provides information responsive to requests from the profile retrieval application 1207 or the profile updating application 1206. For example, the web search server 1232 can provide profile information retrieved from web pages, for example business information about business, or biographical information about users, or even a social network ID. The web search server 1232 is coupled for communication and cooperation with the client devices 1215 and other servers 1202, 1230, 1234 and 1236 by the network 1205.

The third-party servers 1234a-1234n includes various servers and provide various services and associate profile information. For example, the third-party servers 1234a-1234n in in some implementations include an advertisement server, a document server, a blogging server, a news feed server, a video sharing server, a photo sharing server, a map server, a gaming sever, etc. The third-party servers 1234a-1234n may optionally include the profile retrieval application 1207 or the profile updating application 1206 for retrieving or presenting profile information as has been described above. For example, the third-party server 1234n may be a video sharing online server that plays a video responsive to receiving a user request from the client device 1215. The users of the video sharing online server can share video to each other and connect with each other. The video sharing online server can retrieve profile information associated with a certain user who matches the search attributes, and provide that profile information to the profile updating application 1206 of the client device 1215. The third-party servers 1234a-1234n are coupled for communication and cooperation with the client devices 1215 and other servers 1202, 1230, 1232 and 1236 by the network 1205.

Referring now to FIG. 13, an example client device 1215 is shown in more detail. The client device 1215 comprises a software communication mechanism 1306 that couples a processor 1335, a memory 1337, a communication unit 1341, a display device 1345, an optional storage device 1343, a phone dialer application 1330, other applications 1332 and the profile updating application 1206 for communication and cooperation according to some implementations.

The software communication mechanism 1306 may be an object bus (e.g., CORBA), direct socket communication (e.g., TCP/IP sockets) among software modules, remote procedure calls, UDP broadcasts and receipts, HTTP connections, function or procedure calls, etc. Further, any or all of the communication could be secure (SSH, HTTPS, etc). The software communication mechanism 1306 can be implemented on any underlying hardware, for example, a network, the Internet, a bus, a combination thereof, etc.

The processor 1335 includes an arithmetic logic unit, a microprocessor, a general-purpose controller or some other processor array to perform computations and provide electronic display signals to a display device. The processor 1335 is coupled to the software communication mechanism 1306 for communication with the other components. Processor 1335 may process data signals and may comprise various computing architectures including a complex instruction set computer (CISC) architecture, a reduced instruction set computer (RISC) architecture, or an architecture implementing a combination of instruction sets. Although only a single processor is shown in FIG. 13, multiple processors may be included. The processing capability may be limited to supporting the display of images and the capture and transmission of images. The processing capability might be enough to perform more complex tasks, including various types of feature extraction and sampling. Other processors, operating systems, sensors, displays and physical configurations are possible.

The memory 1337 stores instructions and/or data that may be executed by processor 1335. The memory 1337 is coupled to the software communication mechanism 1306 for communication with the other components. The instructions and/or data may include code for performing any and/or all of the techniques described herein. The memory 1337 may be a dynamic random access memory (DRAM) device, a static random access memory (SRAM) device, flash memory or some other memory device known in the art. In some instances, the memory 1337 also includes a non-volatile memory or similar permanent storage device and media for example a disk drive, a CD-ROM device, a DVD-ROM device, a DVD-RAM device, a DVD-RW device, a flash memory device, or some other mass storage device known in the art for storing information on a more permanent basis.

The communication unit 1341 transmits and receives data to and from of the client device 1215 and its components. More specifically, the communication unit 1341 sends data to and from the profile updating application 1206 and the other servers 1202, 1230, 1232, 1234 and 1236 via signal line 1214 and the network 105. The communication unit 1341 is coupled to the software communication mechanism 1306 for communication with other components of the profile updating application 1206. In some instances, the communication unit 1341 includes a port for direct physical connection to the network 1205 or to another communication channel. For example, the communication unit 1341 includes a USB, SD, RJ-45 or similar port for wired communication with the client device 1215. In some other instances, the communication unit 1341 includes a wireless transceiver for exchanging data with the client device 1215 or any other communication channel using one or more wireless communication methods, e.g., IEEE 802.11, IEEE 802.16, BLUETOOTH® or another suitable wireless communication method. In some instances, the communication unit 1341 includes a cellular communications transceiver for sending and receiving data over a cellular communications network e.g., via short messaging service (SMS), multimedia messaging service (MMS), hypertext transfer protocol (HTTP), direct data connection, WAP, e-mail or another suitable type of electronic communication. In some other instances, the communication unit 1341 includes a wired port and a wireless transceiver. The communication unit 1341 also provides other conventional connections to the network for distribution of files and/or media objects using standard network protocols e.g., TCP/IP, HTTP, HTTPS and SMTP.

The display device 1345 is a liquid crystal display (LCD) or any other similarly equipped display device, screen, or monitor. The display device 1345 represents any device equipped to display user interfaces, electronic images and data as described herein. In different embodiments, the display is binary (only two different values for pixels), monochrome (multiple shades of one color), or allows multiple colors and shades. The display device 1345 is preferably a light-weight low-power display. The display device 1345 is coupled to the software communication mechanism 1306 to receive data and images for display.

The storage device 1343 can be a non-transitory memory that stores data used by the profile updating application 1206. In some instances the data is stored temporarily, for example, a cache. The storage device 1343 may be a dynamic random access memory (DRAM) device, a static random access memory (SRAM) device, flash memory or some other memory device known in the art. In some instances, the storage device 1343 also includes a non-volatile memory or similar permanent storage device and media e.g., a hard disk drive, a floppy disk drive, a CD-ROM device, a DVD-ROM device, a DVD-RAM device, a DVD-RW device, a flash memory device, or some other mass storage device known in the art for storing information on a more permanent basis. In the illustrated implementation, the storage device 1343 is communicatively coupled by the software communication mechanism 1306 for communication with the other components of the profile updating application 1206. Although only one storage device 1343 is shown in FIG. 13, multiple storage devices may be included. In some other instances, the storage device 1343 may not be included in the client device 1215 and can be communicatively coupled to the client device 1215 via the network 1205.

The phone dialer application 1330 and other applications 1332 may be software including routines for processing phone call and communication from the client device 1215. The phone dialer application 1330 and other applications 1332 may maintain contact information, contact records, contact lists or books and other phone related functionality. In some instances, the phone dialer application 1330 and other applications 1332 capture and record calling signals or communication history or information relating to phone calls, text messaging or related telephony activity including the call frequency, call recency, call duration, call start time, call end time, call type, phone number called or texted, caller ID of incoming call or text, etc. This information may be provided to the profile updating application 1206. In some instances, the phone dialer application 1330 and other applications 1332 may be a set of instructions executable by the processor 1335 to provide the functionality described above. In some other instances, the phone dialer application 1330 and other applications 1332 can be stored in the memory 1337 of the client device 1215 and can be accessible and executable by the processor 1335.

In some instances, the profile updating application 1206 includes an activity detecting engine 1320, an attribute extraction engine 1322, a profile retrieving engine 1324, a notification engine 1326, and an information updating engine 1328. These components of the profile updating application 1206 are communicatively coupled by the software communication mechanism 1306 to each other and the other components of the client device 1215.

The activity detecting engine 1320 can be software including routines for detecting activity related to the contact information, routing the data of the detected activity to the appropriate module or unit. In some instances, the activity detecting engine 1320 can be a set of instructions executable by the processor 1335 to provide the functionality described below for detecting activity. In some other instances, the activity detecting engine 1320 can be stored in the memory 1337 of the client device 1215 and can be accessible and executable by the processor 1335. In either of the instances, the activity detecting engine 1320 may be adapted for cooperation and communication with the processor 1335 and other components of the client device 1215. The activity detecting engine 1320 detects an activity related to a contact information on the client device 1215. The activity detecting engine 1320 cooperates with the phone dialer application 1330 to receive the calling signals. For example, the activity can be an incoming call from an unknown number on the client device 1215, outgoing call to an unknown number from the client device 1215, adding a new contact item or record to the contact information on the client device 1215, or modifying an existing contact item or record on the contact information on the client device 1215, etc. The activity detecting engine 1320 may ask for permission to access the calling signals and call activity of client device 1215.

The attribute extraction engine 1322 can be software including routines for retrieving one or more attributes associated with the detected activity. In some instances, the attribute extraction engine 1322 can be a set of instructions executable by the processor 1335 to provide the functionality described below for detecting activity. In some other instances, the attribute extraction engine 1322 can be stored in the memory 1337 of the client device 1215 and can be accessible and executable by the processor 1335. In either of the instances, the attribute extraction engine 1322 may be adapted for cooperation and communication with the processor 1335 and other components of the client device 1215. In some instances, the attribute extraction engine 1322 receives the data related to the detected activity (e.g., the calling signals) from the activity detecting engine 1320 via software communication mechanism 1306. The attribute extraction engine 1322 analyzes the detected activity and retrieves attributes from the detected activity. For example, if the detected activity is an incoming phone call or an outgoing phone call, the attribute is the phone number of the call. In some other instances when the detected activity is adding a new contact item or modifying an existing contact item, the attributes extracted by the attribute extraction engine 1322 can be any one or more fields or data from the contact item.

The profile retrieving engine 1324 can be software including routines for retrieving profile information associated with the retrieved one or more attributes. In some instances, the profile retrieving engine 1324 can be a set of instructions executable by the processor 1335 to provide the functionality described below for detecting activity. In some other instances, the profile retrieving engine 1324 can be stored in the memory 1337 of the client device 1215 and can be accessible and executable by the processor 1335. In either of the instances, the profile retrieving engine 1324 may be adapted for cooperation and communication with the processor 1335 and other components of the client device 1215.

In some instances, the profile retrieving engine 1324 receives the attributes from the attribute extraction engine 1322. The profile retrieving engine 1324 may generate a request based on the attributes and sends the request to the social network server 1202 via the communication unit 1341. The profile retrieving engine 1324 receives the response from the social network server 1202 and stores the response in the storage device 1343. In some instances, the response from the social network server 1202 may include a notification having the profile information associated with the one or more attributes. In some other instances, the response from the social network server 1202 may be the profile information associated with the one or more attributes and the interaction history on the social network between the first user 1225a of the client device 1215a and a second user who is related to the detected activity. It should be understood that the profile retrieving engine 1324 may perform a similar processes to those described above with reference to the social network server 1202, but to retrieve information from other social network servers 1202b . . . 1202n, the profile server 1230, the email server 1236, the web search server 1232 or any one of the third-party servers 1234a . . . 1234n.

In some instances, the profile retrieving engine 1324 determines whether to retrieve the profile information prior to generating and sending the request. For example, the profile retrieving engine 1324 determines whether the client device 1215 has an application installed that automatically retrieves the profile information. Since some special dialers or applications automatically retrieve profile information and update the contact information stored at the client device 1215 with this information, it would be redundant for the user to have to review two similar notifications and it also is unnecessary to retrieve the information a second time. Therefore, if an application that automatically retrieves the profile information has been installed, the profile retrieving engine 1324 may retrieve the profile information from the contact information based on recent updates. Similarly, the profile retrieving engine 1324 may determines whether a social network application that already includes the profile information associated with the one or more attributes is installed on the client device 1215 has prior to generating and sending the request. When the profile information is already available at the client device 1215, there is no need to ask for the profile information.

In some instances, the profile retrieving engine 1324 determines which social network account to use for retrieving the profile information where the first user has a plurality of accounts on different social networks prior to generating and sending the request. In some instances, the profile retrieving engine 1324 picks up the first account that it finds on the client device 1215. In some other instances, the profile retrieving engine 1324 looks up all the accounts on the client device 1215 and picks the account with the richest profile information and data. The predetermined rule for picking up account from multiple accounts is adjustable and stored in the storage device 1343. In yet other instances, the first user of the client device 1215 can pick up the account manually or assign a priority level to each social network.

The notification engine 1326 can be software including routines for providing notification to the first user. In some instances, the notification engine 1326 can be a set of instructions executable by the processor 1335 to provide the functionality described below for detecting activity. In some other instances, the notification engine 1326 can be stored in the memory 1337 of the client device 1215 and can be accessible and executable by the processor 1335. In either of the instances, the notification engine 1326 may be adapted for cooperation and communication with the processor 1335 and other components of the client device 1215.

In some instances, the notification engine 1326 provides the notification to the first user 1225 of the client device 1215 by sending the notification to be shown to the display device 1345 for presentation. In some instances, the notification engine 1326 generates the notification from data received from the profile retrieving engine 1324. This can be raw data and the notification must be generate or it can be a notification that has already been generated, for example, by the profile retrieval application 1207. The notification can include the various types of communication history, e.g., email exchange and phone calls etc., between the first user and a second user associated with the detected activity. In another example, the notification can include the retrieved profile information or the social network ID associated with the attributes. In yet another example, the notification can include query to the first user regarding whether the user wants to add the second user as a connection. More detailed examples of notifications have been described above with reference to FIGS. 9A-9D and 10A-10D.

In some instances, the notification engine 1326 determines whether to provide a notification based on predetermined criteria prior to providing the notification to the user. The predetermined criteria are adjustable and stored in the storage device 1343. The criteria may be multiple factors that each reflects a degree of interestingness of the notification to the user. The criteria may take the interaction history between the first user of the client device and a second user associated with the detected activity into consideration. For example, when there were four phone call exchanges during the past week between the two users, it indicates that the two users interacted with each other several times and it is not from an accidentally dialed phone call.

In some instances, the notification engine 1326 determines whether the first user has dismissed a notification associated with the same profile information and the number of times the first user has dismissed similar notifications. The notification engine 1326 may create a threshold of a number of dismissals based on user preference settings or input as to how many notifications about a particular user or subject matters the user wants to see before the sending the notifications ceases. The notification engine 1326 may create a blacklist or do not notify list including the dismissed notifications and the associated social network ID. The blacklist may be stored in the storage device 1343. In some instances, the blacklist may be stored in a per-device way, but not in a per-account way. The notification engine 1326 may check whether the notification to be provide matches any of the dismissed notifications in the blacklist, meaning the first user is not interested in this notification.

The information updating engine 1328 can be software including routines for receiving the user's input responsive to the notification including the profile information and updating a profile with that profile information. For example, the profile may be the first user's profile on the client device 1215, in the social network servers 1202a . . . 1202n, the profile server 1230, the email server 1236, the web search server 1232 or any one of the third-party servers 1234a . . . 1234n. In some instances, the information updating engine 1328 can be a set of instructions executable by the processor 1335 to provide the functionality described below for receiving the user's input responsive to the notification including the profile information and updating a profile with that profile information. In some other instances, the information updating engine 1328 can be stored in the memory 1337 of the client device 1215 and can be accessible and executable by the processor 1335. In either of the instances, the information updating engine 1328 may be adapted for cooperation and communication with the processor 1335 and other components of the client device 1215. In some instances, the information updating engine 1328 receives an input responsive to the notification from the first user. For example, the input may indicate that the first user want to connect with the second user on social network. In another example, the input may indicate that the user wants to store the profile information of the second user as a contact in the contact information on the client device 1215. The information updating engine 1328 updates the first user's social graph on a social network with the profile information based on the input from the user. For example, responsive to the user's input indicating that the first user wants to connect with the second user, the social network adds the other users as a connection on a social network.

In some instances, the information updating engine 1328 may also update contact information of a first user in multiple external databases with profile information associated with the second user. The contact information of the first user may include, but not limited to, a contact list, a social graph, a profile, etc. The profile information of the second user may include, but not limited to, a name, a phone number, a location, etc. For example, the information updating engine 1328 may update a contact list of the first user in an external database directed to business networking with a name and a phone number of a service provider in response to receiving a call from the service provider. Or, based on a call from the first user to a journal editor who is working on publication of an article of the first user, the information updating engine 1328 may update a publication group of the first user in an external database centered on academics with available hours of the journal editor. Or the information updating engine 1328 may update a match list of the first user in an external database directed to dating with a name, a photo, a meeting time, a meeting location of a contact in response to saving the contact that matches user interests of the first user. Or the information updating engine 1328 may add a new contact name in a social graph of the first user in different social networks.

In some instances, once the contact information of the first user is updated with the profile information associated with the second user, the information updating engine 1328 also connects the first user to the second user. The second user may be associated with a call with the first user and determined by the phone number of the call. The second user may also be a new contact saved in the external database. In some instances, the information updating engine 1328 may suggest a connection between the first user and the second user and actually establish the connection between the first user and the second user in response to receiving an acceptance of the suggested connection from at least one of the first and second users. For example, the information updating engine 1328 may set up a bi-directional connection between the first and second users upon receiving acceptance from both the first user and the second user, and may set up a single-directional connection from one user to another user upon merely receiving acceptance from one of the two users. In other instances, the information updating engine 1328 may notify the first user to connect with the second user.

Referring now to FIG. 14, a block diagram shows an example social network server 1202a in more detail. The social network server 1202a comprises a software communication mechanism 1306 that couples a processor 1335, a memory 1337, a communication unit 1341, a storage device 1343, the social network application 1204 and the profile updating application 1206 for communication and cooperation according to some implementations. The implementation of the software communication mechanism 1306, the processor 1335, the memory 1337, the communication unit 1341, the storage device 1343 and the social network application 1204 have been described above, and they have the same or similar functionality as part of the social network server 1202a so that description will not be repeated here.

The profile retrieval application 1207 generates a notification including the profile information and sends the notification to the first user of the client device 1215. The example notifications are describe in more detail in FIGS. 9 and 10. The profile retrieval application 1207 may include a request receiving engine 1422, a profile information retrieving engine 1428, an API (Application Program Interface) 1420, a Web search engine 1424, an Email exchange data retrieving engine 1426, a Name resolution service engine 1432 and optionally a spam filter 1430. These components of the profile retrieval application 1207 are communicatively coupled by the software communication mechanism 1306 to each other and the other components of the social network server 1202a.

The request receiving engine 1422, the profile information retrieving engine 1428, the application program interface (API) 1420, the web search engine 1424, the email exchange data retrieving engine 1426, the name resolution service engine 1432 and the spam filter 1430 may be software including routines for performing the operations and functions described below. In some instances, the request receiving engine 1422, the profile information retrieving engine 1428, the application program interface (API) 1420, the web search engine 1424, the email exchange data retrieving engine 1426, the name resolution service engine 1432 and the spam filter 1430 can be sets of instructions executable by the processor 1335 to provide the functionality described below. In some other instances, the request receiving engine 1422, the profile information retrieving engine 1428, the application program interface (API) 1420, the web search engine 1424, the email exchange data retrieving engine 1426, the name resolution service engine 1432 and the spam filter 1430 can be stored in the memory 1337 of the social network server 1202a and can be accessible and executable by the processor 1335. In any of the instances, the request receiving engine 1422, the profile information retrieving engine 1428, the application program interface (API) 1420, the web search engine 1424, the email exchange data retrieving engine 1426, the name resolution service engine 1432 and the spam filter 1430 may be adapted for cooperation and communication with the processor 1335 and other components of social network server 1202a.

In some instances, the request receiving engine 1422 receives a request from the client device 1215 for profile information based on one or more attributes. To be more specific, the request receiving engine 1422 receives a request from the profile retrieving engine 1324 of the profile updating application 1206. For example, the request receiving engine 1422 receives a request including a phone number for profile information. In some other instances, the request may include more data attributes from data fields of a modified contact record.

In some instances, the profile retrieval application 1207 retrieves profile information from multiple databases, for example, find a social network ID associated with the one or more attributes using Name Resolution Service. The API 1420, web search engine 1424, email exchange data retrieving engine 1426, and name resolution service engine 1432 work together to look up the social network id associated with the one or more attributes. For example, the profile retrieval application 1207 may interact with the API 1420 to the social network application 1204 in order to retrieve the social network ID. In another example, the profile retrieval application 1207 may interact with the web search engine 1424 to perform a search of the Internet to find the social network ID associated with the one or more attributes. In yet another example, the profile retrieval application 1207 may interact with the email exchange data retrieving engine 1426 to communicate with the email server 1236 to retrieve the social network ID. It should be noted that the profile retrieval application 1207 may interact with other sources or the combination of the above mentioned sources and other sources to find the social network ID. Under some circumstances, the profile retrieval application 1207 may find more than one social network IDs that associated with the same attribute or the same group of attributes. The name resolution service engine 1432 is utilized to further identify the most likely social network ID from other related social network IDs.

In some instances, the profile information retrieving engine 1428 retrieves profile information associated with the social network ID or the attributes. For example, the retrieve profile information may include the following: age, gender, geographical location, profile photo, phone number, work information, education, browsed content, registered applications, posts, comments, reshares, endorsements, interests, groups joined by a user associated with the number, etc.

In some instances, the spam filter 1430 may calculate a score for the social network ID to determine whether to provide the notification to the client device 1215. In some instances, the score is calculated based on frequency and other factors. For example, when activity is a call and this is the third phone call between the first user and the second user associated with this phone number during the past week, the score for this social network ID is higher than if there were only a single call between the two users. The spam filter 1430 determines whether the score is above a predetermined threshold. If the score is not above the predetermined threshold, then spam filter 1430 prevents the profile information retrieving engine 1428 sends the notification to the client device 1215. The purpose of spam filter 1430 is to ensure that the user is not presented with too many the notifications so that user ignores or is bothered by the notifications. Other factors may also be taken into consideration when calculate the score, e.g., email exchange frequency, whether the second user is already a contact in the contact information, etc. To be noted, the calculation formula is adjustable by different cases and stored in the storage device 1443.

Reference in the specification to “some instances” or “an instance” means that a particular feature, structure, or characteristic described in connection with the instance is included in at least some instances of the description. The appearances of the phrase “in some instances” in various places in the specification are not necessarily all referring to the same instance.

Some portions of the detailed descriptions that follow are presented in terms of algorithms and symbolic representations of operations on data bits within a computer memory. These algorithmic descriptions and representations are the means used by those in the data processing arts to most effectively convey the substance of their work to others in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms for example “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present implementation of the specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware instance, an entirely software instance or an instance containing both hardware and software elements. In a preferred implementation, the specification is implemented in software, which includes but is not limited to firmware, resident software, microcode, etc.

Furthermore, the description can take the form of a computer program product accessible from a computer-usable or computer-readable medium (or other non-transitory storage medium) providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the instances of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. It should be understood that the specification may be implemented in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the specification, which is set forth in the following claims.

Further to the descriptions above, a user may be provided with controls allowing the user to make an election as to both if and when systems, programs or features described herein may enable collection of user information (e.g., information about a user's social network, social actions or activities, profession, a user's preferences, a user's phone number, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

What is claimed is:

1. A computer-implemented method comprising:
detecting an action performed by a first user on a mobile computing device;
determining, using the mobile computing device, an attribute associated with the detected action;
retrieving, using the mobile computing device, profile information associated with the attribute from an external database; and
providing, using the mobile computing device, the profile information for storage in a profile of the first user.

2. The method of claim 1 wherein the action is sending or receiving a telephone call using the mobile computing device.

3. The method of claim 1 wherein the action is creating or modifying contact information stored on the mobile computing device.

4. The method of claim 1 wherein the profile of the first user is part of contact information stored on the mobile computing device.

5. The method of claim 1 wherein the profile of the first user is on a social network service.

6. The method of claim 5 wherein providing the profile information for storage includes updating a social graph of the first user with a second user determined from the profile information.

7. The method of claim 1 comprising:
determining whether to present the profile information on the mobile computing device;
responsive to a determination to present the profile information on mobile computing device, generating a notification including the profile information and providing the notification for display on the mobile computing device.

8. The method of claim 7 wherein determining whether to present the profile information on the mobile computing device comprises:
receiving a calling signal;
determining a parameter from the calling signal;
determining whether the parameter from the calling signal satisfies a predefined threshold; and
responsive to a determination that the parameter satisfies the predefined threshold, presenting the profile information.

9. The method of claim 7 wherein determining whether to present the profile information on the mobile computing device comprises:
receiving a social signal;
determining a parameter from the social signal;
determining whether the parameter from the social signal satisfies a predefined threshold; and
responsive to a determination that the parameter satisfies the predefined threshold, presenting the profile information.

10. The method of claim 1 wherein retrieving the profile information includes:
identifying one or more global databases to which the first user has access;
selecting a first database from the one or more global databases based on frequency of use of the one or more global databases;
sending a query to the first database; and
receiving and using a query result from the first database as the profile information.

11. A computer-implemented method comprising:
receiving, using one or more computing devices, an attribute associated with an action of a first user on a mobile computing device;
retrieving, using the one or more computing devices, profile information associated with the attribute from a first global database;
determining, using one or more computing devices, whether to update a profile with the profile information; and
responsive to determining to update the profile, providing, using one or more computing devices, the profile information for storage in the profile.

12. The method of claim 11 wherein providing the profile information for storage in the profile includes sending the profile information to a mobile device for storage in contact information on the mobile device.

13. The method of claim 11 wherein providing the profile information for storage in the profile includes sending the profile information to a social network service for storage in the profile of the first user on the social network service.

14. The method of claim 11 wherein providing the profile information for storage includes updating a social graph of the first user with a second user determined from the profile information.

15. The method of claim 11 wherein determining whether to update the profile with the profile information includes:
determining whether to generate a notification to the first user;
responsive to a determination to generate the notification,
generating the notification including the profile information;
providing the notification for presentation to the first user;
receiving a confirmation to update the profile of the first user; and
responsive to receiving the confirmation, storing the profile information in the profile of the first user.

16. The method of claim 11 wherein determining whether to update the profile with the profile information includes determining whether the first user has dismissed a prior notification to update the profile with the profile information.

17. The method of claim 11 wherein determining whether to update the profile with the profile information includes:
receiving a calling signal;
determining a parameter from the calling signal;
determining whether the parameter from the calling signal satisfies a predefined threshold; and
responsive to a determination that the parameter satisfies the predefined threshold, updating the profile with the profile information.

18. The method of claim 11 wherein determining whether to update the profile with the profile information includes:
receiving a social signal;
determining a parameter from the social signal;
determining whether the parameter from the social signal satisfies a predefined threshold; and
responsive to a determination that the parameter satisfies the predefined threshold, updating the profile with the profile information.

19. The method of claim 11 wherein determining whether to update the profile with the profile information comprises:
identifying a plurality of social networks on which the first user has a profile;
selecting a social network from the plurality of social networks based on a predetermined rule; and
updating the profile of the first user in the selected social network with the profile information.

20. A system comprising:
a processor; and
a memory storing instructions that, when executed, cause the system to:
receive an attribute associated with an action of a first user on a mobile computing device;
retrieve profile information associated with the attribute from a first global database;
determine whether to update a profile with the profile information;
responsive to a determination to update the profile, provide the profile information for storage in the profile.

21. The system of claim 20, wherein provision of the profile information for storage in the profile includes sending the profile information to a mobile device for storage in contact information on the mobile device.

22. The system of claim 20, wherein provision of the profile information for storage in the profile includes sending the profile information to a social network server for storage in the profile of the first user on the social network.

23. The system of claim 20, wherein provision of the profile information for storage includes updating a social graph of the first user with a second user determined from the profile information.

24. The system of claim 20, wherein the memory also stores instructions that, when executed, cause the system to:
determine whether to generate a notification to the first user;
generate the notification including the profile information;
provide the notification for presentation to the first user;
receive a confirmation to update the profile of the first user; and
store the profile information in the profile of the first user.

25. The system of claim 20, wherein the determination to update the profile with the profile information includes determining whether the user has dismissed a prior notification to update the profile with the profile information.

26. The system of claim 20, wherein the memory also stores instructions that, when executed, cause the system to:
receive a calling signal;
determine a parameter from the calling signal;
determine whether the parameter from the calling signal satisfies a predefined threshold; and
update the profile with the profile information.

27. The system of claim 20, wherein the memory also stores instructions that, when executed, cause the system to:
receive a social signal;
determine a parameter from the social signal;
determine whether the parameter from the social signal satisfies a predefined threshold; and
update the profile with the profile information.

28. The system of claim 20, wherein determining whether to update the profile with the profile information comprises:
identifying a plurality of social networks on which the first user has a profile;
selecting a social network from the plurality of social networks based on a predetermined rule; and
updating the profile of the first user in the selected social network with the profile information.
